(19) United States
(12) Patent Application Publication
(10) Pub. No.: US 2026/0281868 A1
(43) Pub. Date: Sep. 17, 2026

(54) METHODS AND APPARATUS FOR MULTIHOP LAYER-2 UE-TO-UE RELAY UNICAST ROUTING

(71) Applicant: InterDigital Patent Holdings, Inc., Wilmington, DE (US)

(72) Inventors: Joe Huang, Montville, NJ (US); Jung Je Son, Warrington, PA (US); Martino Freda, Laval, CA (US); Sudhir Pattar, Mount Laurel, NJ (US); Philip Leithead, King of Prussia, PA (US)

(73) Assignee: InterDigital Patent Holdings, Inc., Wilmington, PA (US)

(21) Appl. No.: 19/013,844

(22) Filed: Jan. 8, 2025

(51) Int. Cl. H04W 40/22; H04W 76/14

(52) U.S. Cl. CPC H04W 40/22; H04W 76/14

(57) ABSTRACT

A wireless transmit/receive unit (WTRU)-to-WTRU (W2W) relay is configured to determine multihop connection information, and to provide a local WTRU ID for and end-to-end (E2E) source layer-2 ID (source WTRU IDa) and a local WTRU ID for an E2E target layer-2 ID (target WTRU IDa) to the source remote WTRU and a second W2W relay. The W2W relay is configured to store a route entry from the source WTRU to the target WTRU and from the target WTRU to the source WTRU in an L2 relay routing table, to create a next-hop WTRU ID mapping table, to receive a first packet from the source remote WTRU that comprises the source WTRU IDa and the target WTRU IDa, and to determine an egress link based on the source WTRU IDa and the target WTRU IDa in the SRAP header in the first packet and the L2 relay routing table.

### STATEMENT OF GOVERNMENT RIGHTS

This invention was made with Government support under Contract No. N00014-21-C-1080 awarded by the Office of Naval Research. The Government has certain rights in the invention.

### BACKGROUND

5G proximity service (ProSe) defined several features and procedures such as 5G ProSe Direct Discovery, 5G ProSe Direct Communication, 5G ProSe UE-to-Network (U2N) Relay, and 5G ProSe UE-to-UE (U2U) Relay. 5G ProSe UE-to-UE Relay enables indirect communication between two End UEs. For UE-to-UE Relay, 5G ProSe UE-to-UE Relay Discovery and 5G ProSe Communication via UE-to-UE Relay are defined.

For 5G ProSe UE-to-UE Relay Discovery, both Model A and Model B discovery are supported. Model A uses a single discovery protocol message (Announcement). Model B uses two discovery protocol messages (Solicitation and Response). Discovery integrated into PC5 unicast link establishment procedure is also supported.

5G ProSe Communication via a UE-to-UE Relay is possible with a Layer 2 UE-to-UE Relay or a Layer 3 UE-to-UE Relay. For a Layer 2 UE-to-UE Relay and Layer 3 UE-to-UE Relay, 5G ProSe communication setup with discovery procedures is defined. Discovery integrated into a PC5 unicast link establishment procedure is defined.

With Layer2 UE-to-UE Relay, an end-to-end (E2E) PC5 link is established between the End UEs, via the Relay. PC5-Signalign (PC5-S) messages may then be exchanged between End UEs.

With Layer3 UE-to-UE Relay, each End UE establishes a PC5 link with the Relay and the Relay forwards messages towards End UEs. PC5-S messages are exchanged between End UEs and the Relay.

With Layer3 UE-to-UE Relay, when IP based data connection is used, after a PC5 link setup with the Relay, each End UE may be assigned an IP address by the Relay which may be based on a Dynamic Host Configuration Protocol (DHCP) procedure or each End UE may assign its own IP address, which may be based on a link local IP address assignment procedure, and inform to the Relay. Whether DHCP or link local IP address assignment is used is determined during a security connection setup between End UE and UE-to-UE Relay.

### SUMMARY

A wireless transmit/receive unit (WTRU)-to-WTRU (W2W) relay may be configured to perform a multihop layer-2 W2W relay unicast routing method. The W2W relay may be configured to determine multihop connection information. The multihop connection information may comprise: a number of hops to a source remote WTRU and a next-hop Layer-2 identification (ID) to the source remote WTRU, a number of hops to a target remote WTRU and a next-hop Layer-2 identification (ID) to the target remote WTRU, and end-to-end (E2E) source layer-2 ID and a E2E target layer-2 ID. The W2W relay may be configured to provide or send, to the source remote WTRU and a second W2W relay: a local WTRU ID for the E2E source layer-2 ID (source WTRU IDa), the E2E source layer-2 ID, a local WTRU ID for the E2E target layer-2 ID (target WTRU IDa), and the E2E target layer-2 ID. The W2W relay may be configured to store a route entry from the source remote WTRU to the target remote WTRU in an L2 relay routing table. The W2W relay may be configured to store a route entry from the target remote WTRU to the source remote WTRU in the L2 relay routing table. The W2W relay may be configured to create a next-hop WTRU ID mapping table. The W2W relay may be configured to receive a first packet from the source remote WTRU that comprises the source WTRU IDa and the target WTRU IDa in a sidelink relay adaption protocol (SRAP) header and SRAP data. The W2W relay may be configured to determine an egress link based on the source WTRU IDa and the target WTRU IDa in the SRAP header in the first packet and the L2 relay routing table. The W2W relay may be configured to map or associate the source WTRU IDa and the target WTRU IDa to a source WTRU ID allocated by the second W2W relay (source WTRU IDb) and a target WTRU ID allocated by the second W2W relay (target WTRU IDb) based on the next-hop WTRU ID mapping table. The W2W relay may be configured to send a second packet to the second W2W relay. The second packet may comprise an egress SRAP header that comprises the source WTRU IDb and the target WTRU IDb, and wherein the second packet comprises the SRAP data.

The W2W relay may be configured to determine multihop connection information in response to receiving a direct communication request (DCR) message or link modification request (LMR) message from the source remote WTRU, and in response to receiving a direct communication accept (DCA) message or link modification accept (LMA) message from the second W2W relay. The multihop connection information may be sent from a proximity service (ProSe) layer to an access stratum (AS) layer in response to receiving a direct communication accept (DCA) message or link modification accept (LMA) message from the second W2W relay. The source WTRU IDa, the E2E source layer-2 ID, the target WTRU IDa, and the E2E target layer-2 ID may be sent in radio resource control (RRC) reconfiguration sidelink message. The source WTRU IDa and the target WTRU IDa may be allocated by an access stratum (AS) layer. The next-hop WTRU ID mapping table may comprise a next-hop layer-2 ID, ingress source and target WTRU IDs, and egress source and target WTRU IDs. A route entry in the L2 relay routing table may comprise: a source WTRU ID, a destination WTRU ID, a number of hops to destination, and a next hop layer-2 ID. The W2W relay may be configured to receive a message from the second W2W relay comprising a second local source WTRU ID (source WTRU IDb), a second local target WTRU ID (target WTRU IDb), the E2E source layer-2 ID, and the E2E target layer-2 ID. The W2W relay may be configured to create the next-hop WTRU ID mapping table based on the received message from the second W2W relay. The determining multihop connection information may be performed during a PC5 connection setup procedure. The W2W relay may be configured to swap local WTRU IDs based on the next-hop WTRU ID mapping table.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a ProSe layer multihop UE-to-UE Relay link establishment/connection setup procedure;

FIG. 3A shows an example of a multihop Layer-2 UE-to-UE Relay link establishment/connection setup procedure;

FIG. 3B shows an example of an alternative multihop Layer-2 UE-to-UE Relay link establishment/connection setup procedure;

FIG. 4 shows an example of local UE ID allocation and neighbor notification for multihop Layer-2 UE-to-UE Relay;

FIG. 5 shows an example procedure of a U2U relay UE using local UE IDs allocated by itself for egress traffic;

FIG. 6 shows an example procedure of the third embodiment of a U2U relay UE using local UE IDs allocated by itself for egress traffic;

FIG. 7 shows an example procedure of a U2U Relay UE using local UE IDs allocated by the next hop U2U Relay UE for egress traffic;

FIG. 8 shows an example procedure of the fourth embodiment of a U2U relay UE using local UE IDs allocated by the next hop U2U Relay UE for egress traffic;

FIG. 9 shows an example multihop Layer-2 UE-to-Network Relay with a “U2U Relay +U2N Relay” architecture;

FIG. 10 shows an example multihop Layer-2 UE-to-Network (U2N) Relay via translation between U2N UE ID and U2U UE IDs;

FIG. 11A shows an example U2N Relay Uu-SRAP Data PDU format;

FIG. 11B shows an example multihop U2N Relay PC5-SRAP Data PDU format;

FIG. 12 shows an example multihop Layer-2 UE-to-Network Relay via encapsulation of U2N UE ID by U2U UE IDs;

FIG. 13A shows an example multihop U2N Relay PC5-SRAP Data PDU format with encapsulation (SRB0);

FIG. 13B shows an example multihop U2N Relay PC5-SRAP Data PDU format with encapsulation (non-SRB0);

FIG. 14 shows an example sharing of a PC5 Relay RLC channel between multihop Layer-2 UE-to-Network Relay and Layer-2 UE-to-UE Relay via a ‘Multihop U2N’bit;

FIG. 15 shows an example sharing of a PC5 Relay RLC channel between multihop Layer-2 UE-to-Network Relay and single-hop Layer-2 UE-to-Network Relay via a ‘Multihop U2N’ bit;

FIG. 16 shows an example sharing of a PC5 Relay RLC channel between Layer-2 UE-to-UE Relay and single-hop Layer-2 UE-to-Network Relay via a ‘Bearer Type’bit;

FIG. 17 shows an example procedure for a Source UE-to-UE Remote UE;

FIG. 18 shows an example procedure for a first UE-to-UE Relay UE;

FIG. 19 shows an example procedure for a second UE-to-UE Relay UE;

FIG. 20 shows an example procedure for a Target UE-to-UE Remote UE;

FIG. 21 shows an example procedure for a Source UE-to-UE Remote UE;

FIG. 22 shows an example procedure for a first UE-to-UE Relay UE;

FIG. 23 shows an example procedure for a second UE-to-UE Relay UE;

FIG. 24 shows an example procedure for a Target UE-to-UE Remote UE;

FIG. 25. shows an example procedure of a UE-to-UE Relay UE using a next-hop UE ID mapping table; and

FIG. 26. shows an example procedure of a UE-to-UE Relay UE using a previous-hop UE ID mapping table.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communication Systems

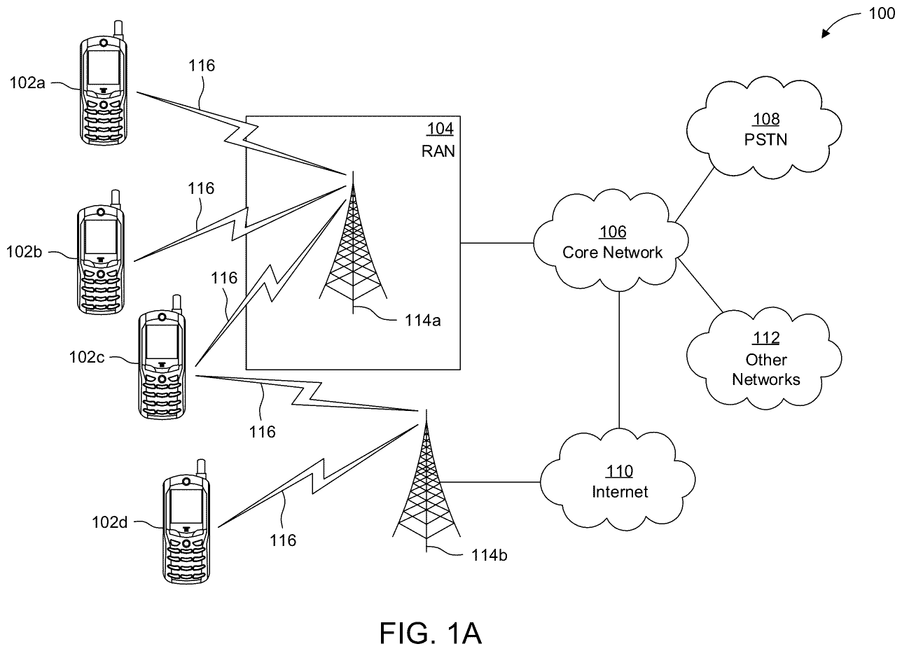

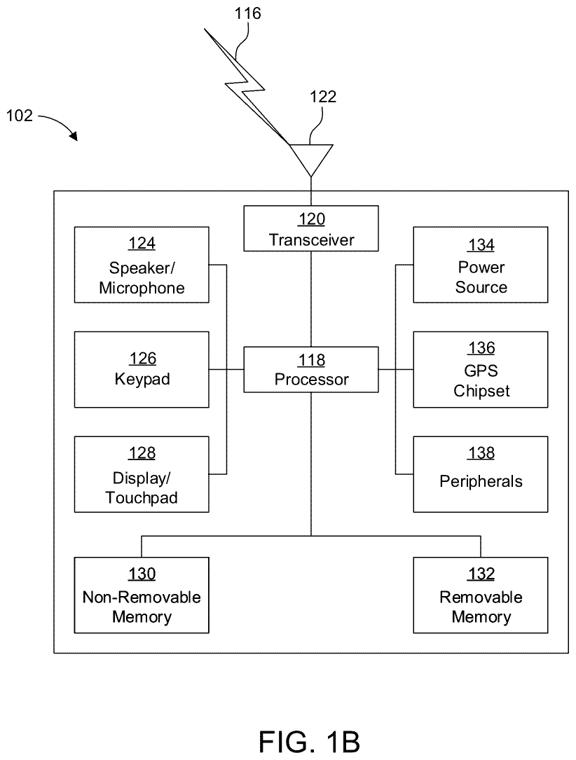

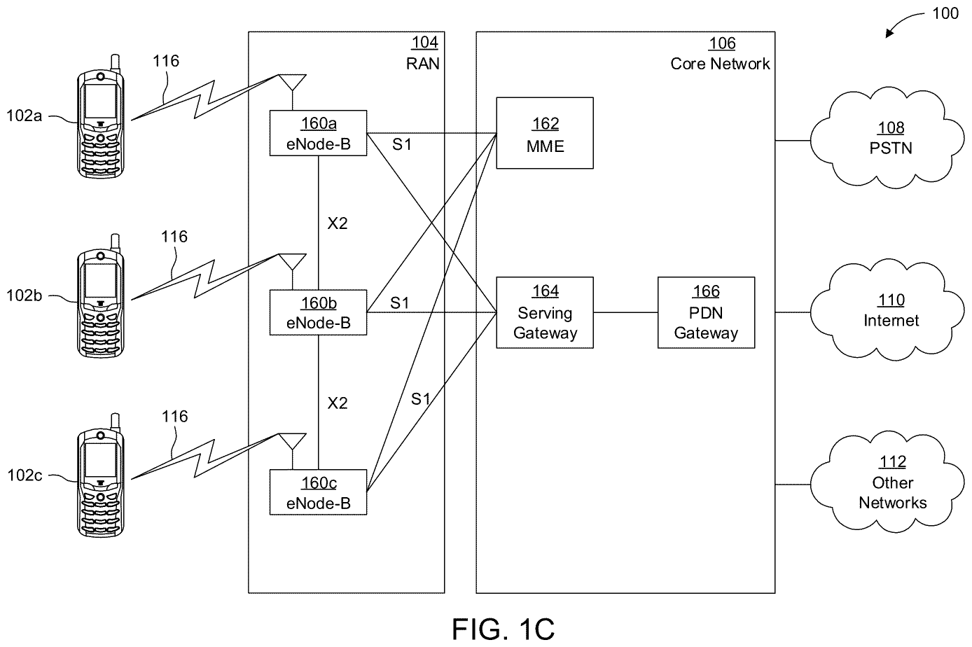

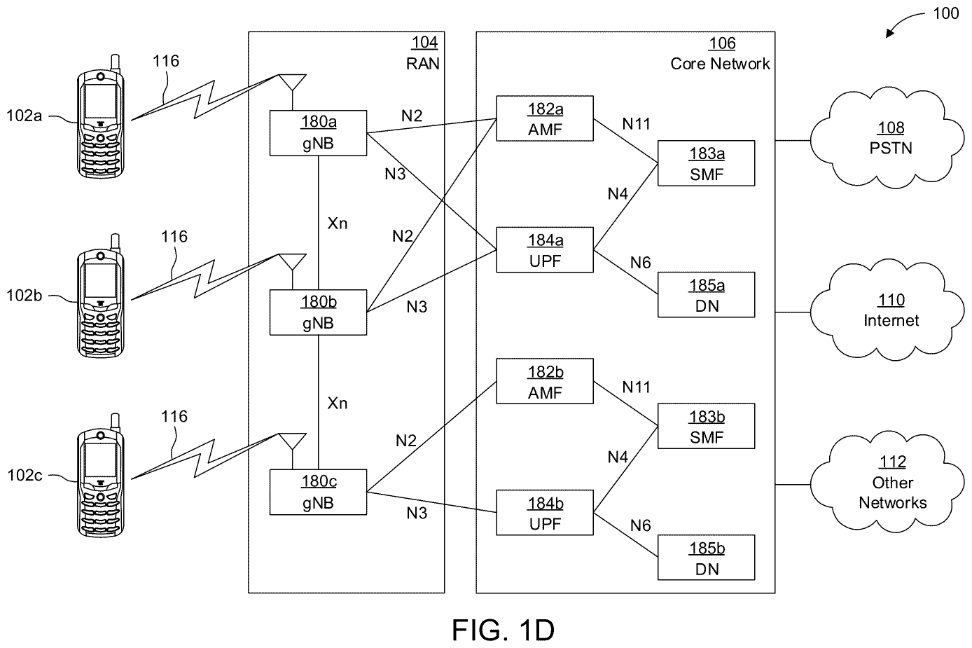

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, UE may be used interchangeably with WTRU and a UE-to-UE relay or U2U relay may be used interchangeably with a WTRU-to-WTRU relay or W2W relay.

After a connection setup between two End UEs via a UE-to-UE Relay, each End UE may keep monitoring the channel status of a PC5 link and when a link quality goes below a threshold value, the End UE may select another UE-to-UE Relay for the connection between two End UEs.

For UE-to-UE Relay Reselection, UE-to-UE Relay Discovery procedures may be used or the negotiated 5G ProSe UE-to-UE Relay Reselection procedure may be used.

In the negotiated UE-to-UE Relay Reselection, one End UE may initiate the UE-to-UE Relay Reselection procedure. End UEs may negotiate a new UE-to-UE Relay using the existing connection and establish the communication via the reselected UE-to-UE Relay prior to releasing the communication via the current 5G ProSe UE-to-UE Relay.

A Multihop for UE-to-Network (U2N) Relay may enable a Remote UE to discover and communicate with a U2N Relay via one or more U2U Relays. A Multihop UE-to-UE Relay may enable End UEs to discover and communicate with each other via more than one U2U Relay.

The multihop capability is deemed crucial for mission critical communications (e.g., first responders) and in general needed to enhance coverage (e.g., indoor).

In 3GPP Release 18 Layer-2 UE-to-UE (U2U) Relay, only one U2U Relay UE is considered, which is responsible for allocating the local UE IDs for the U2U Remote UEs. Egress link determination is based on the UE ID fields in a Service Data Adaptation Protocol (SRAP) header. After local UE IDs of the source/target U2U Remote UEs are allocated by the U2U Relay UE, the pair of allocated local UE IDs and the Layer-2 ID of the target U2U Remote UE are provided to the source U2U Remote UE, and the pair of allocated local UE IDs and the Layer-2 ID of source U2U Remote UE are provided to the target U2U Remote UE using RRCReconfigurationSidelink messages for making the association between the local UE ID and the Layer-2 ID.

To support unicast routing for multihop Layer-2 UE-to-UE Relay in a mesh network, the following issues need to be addressed: (i) Layer-2 ID uniqueness: How to ensure Layer-2 ID uniqueness to the extent that on each node along an end-to-end path, every pair of [source Layer-2 ID, target Layer-2 ID] can uniquely identify an end-to-end link? (ii) Local UE ID allocation: Who and how to allocate SRAP local UE IDs in the case of multihop UE-to-UE Relay with two or more U2U Relay UEs? (iii) Egress link determination: How to determine the egress link on a PC5 interface based on the UE ID fields in the SRAP header? (iv) End-to-end L2 routing: How to perform end-to-end L2 routing based on the UE IDs in the SRAP header?

In conventional IP routing, each node is allocated or pre-configured with a globally unique IP address within the considered routing network. IP routing may be facilitated by a Routing Table, with a route entry typically comprising at least a destination IP address, number of hops to the destination and a next-hop IP or interface address. A Routing Table may be set up based on the exchange of routing protocol messages among networking nodes. It is also possible to perform routing by storing the hop-by-hop routing information in packet header without setting up Routing Tables.

In the case of multihop UE-to-UE Relay in a mesh network, a ProSe layer needs to perform UE-to-UE Relay discovery to find an end-to-end route and perform hop-by-hop link establishment/connection setup from the source U2U Remote UE to the target U2U Remote UE. In this regard, running a separate SRAP control plane Layer-2 routing protocol at an access stratum (AS) layer for multihop Layer-2 UE-to-UE Relay may be redundant and inefficient. It is desirable to have solutions that can facilitate multihop Layer-2 UE-to-UE Relay based on route information available at the ProSe layer without relying on an explicit SRAP control plane L2 routing protocol.

There is a need to determine how to support multihop Layer-2 UE-to-UE Relay with two or more L2 U2U Relay UEs between L2 U2U Remote UEs in a UE-to-UE Relay mesh network without relying on an explicit SRAP control plane L2 routing protocol.

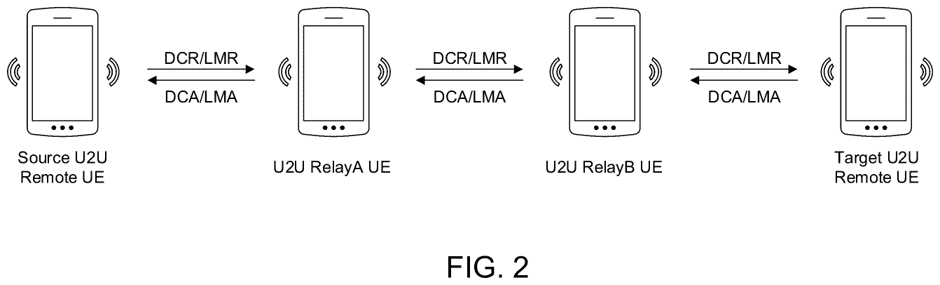

FIG. 2 shows an example of a ProSe layer multihop UE-to-UE Relay link establishment/connection setup procedure. A ProSe layer multihop UE-to-UE Relay link establishment/connection setup procedure may be used to set up a multihop PC5 connection over an end-to-end path. After multihop UE-to-UE Relay discovery, the source U2U Remote UE may establish connectivity or modify an existing PC5 connection with a U2U Relay UE, through a Direct Communication Request (DCR) or a Link Modification Request (LMR). The U2U Relay UE may establish connectivity with the next U2U Relay UE along the discovered path, through a DCR or LMR. The process may continue until the target U2U Remote UE is reached. The target U2U Remote UE may send a Direct Communication Accept (DCA) or a Link Modification Accept (LMA) to a selected U2U Relay UE that the target U2U Remote UE receives the DCR/LMR from. Each U2U Relay UE along the selected reverse path may send the DCA or LMA hop by hop to the source U2U Remote UE to complete the multihop PC5 link establishment/connection setup over the end-to-end path.

During the multihop PC5 connection setup over an end-to-end path as shown in FIG. 2, U2U RelayA UE may record the number of hops to the source U2U Remote UE (here, 1, directly connected) upon the reception of the DCR/LMR from the source U2U remote UE and provide/send the number of hops to the source U2U Remote UE and the source Layer-2 ID of the source U2U Remote UE (e.g., associated with a received Direct Security Mode (DSM) Complete message during security establishment with the source U2U Remote UE after receiving q DCR from the source U2U Remote UE) as the Layer-2 ID of the source U2U Remote UE in the DCR/LMR sent to U2U RelayB UE. U2U RelayA UE may further record the Layer-2 ID of the source U2U Remote UE as the next-hop Layer-2 ID to the source U2U Remote UE.

U2U RelayB UE may record the number of hops to the source U2U Remote UE (here, 2) by incrementing by 1 the number of hops to the source U2U Remote UE information received in the DCR/LMR from U2U RelayA UE and provide/send the number of hops to the source U2U Remote UE and the Layer-2 ID of the source U2U Remote UE in the DCR/LMR sent to the target U2U Remote UE. U2U RelayB UE may further record the Layer-2 ID of U2U RelayA UE (e.g., associated with the received DSM Complete message during security establishment with U2U RelayA UE after receiving DCR from the U2U RelayA UE) as the next-hop Layer-2 ID to the source U2U Remote UE.

The target U2U Remote UE may record the number of hops to the source U2U Remote UE (here, 3) by incrementing by 1 the number of hops to the source U2U Remote UE information received in the DCR/LMR from U2U RelayB UE. The target U2U Remote UE may further record the Layer-2 ID of U2U RelayB UE (e.g., associated with the received DSM Complete message during security establishment with U2U RelayB UE after receiving DCR from the U2U RelayB UE) as the next-hop Layer-2 ID to the source U2U Remote UE.

In addition, U2U RelayB UE may record the number of hops to the target U2U Remote UE (here, 1, directly connected) upon the reception of DCA/LMA from the target U2U remote UE and provide/send the number of hops to the target U2U Remote UE and the source Layer-2 ID of the target U2U Remote UE (e.g., associated with the received DCA/LMA message from the target U2U Remote UE) as the Layer-2 ID of the target U2U Remote UE in the DCA/LMA sent to U2U RelayA UE. U2U RelayB UE may further record the Layer-2 ID of the target U2U Remote UE as the next-hop Layer-2 ID to the target U2U Remote UE.

U2U RelayA UE may record the number of hops to the target U2U Remote UE (here, 2) by incrementing by 1 the number of hops to the target U2U Remote UE information received in the DCA/LMA from U2U RelayB UE and provide/send the number of hops to the target U2U Remote UE and the Layer-2 ID of the target U2U Remote UE in the DCA/LMA sent to the source U2U Remote UE. U2U RelayA UE may further record the Layer-2 ID of U2U RelayB UE (e.g., associated with the received DCA/LMA message from U2U RelayB UE) as the next-hop Layer-2 ID to the target U2U Remote UE.

The source U2U Remote UE may record the number of hops to the target U2U Remote UE (here, 3) by incrementing by 1 the number of hops to the target U2U Remote UE information received in the DCA/LMA from U2U RelayA UE. The source U2U Remote UE may further record the Layer-2 ID of U2U RelayA UE (e.g., associated with the received DCA/LMA message from U2U RelayA UE) as the next-hop Layer-2 ID to the target U2U Remote UE.

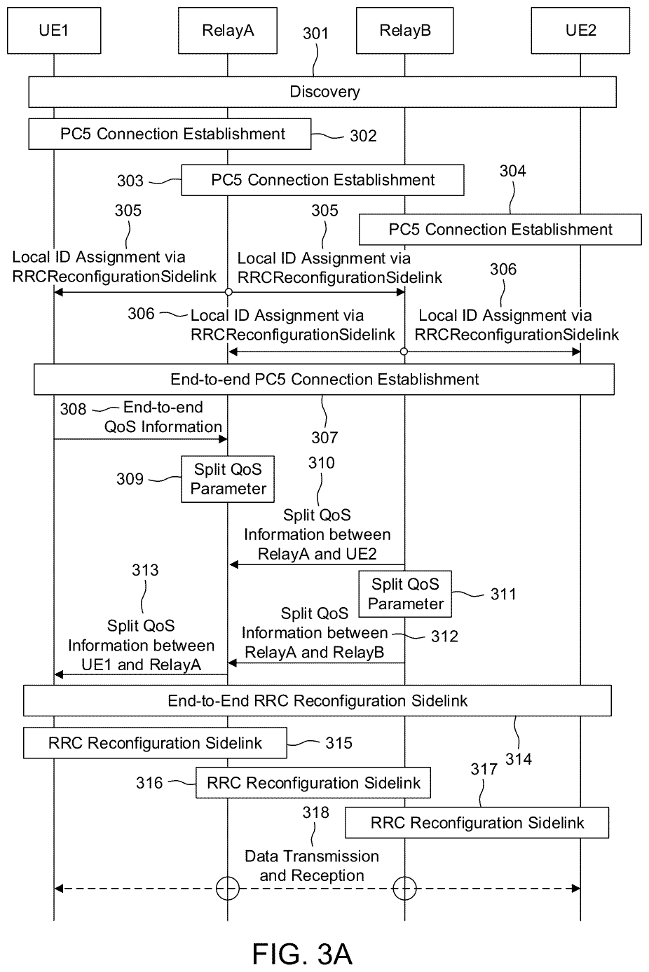

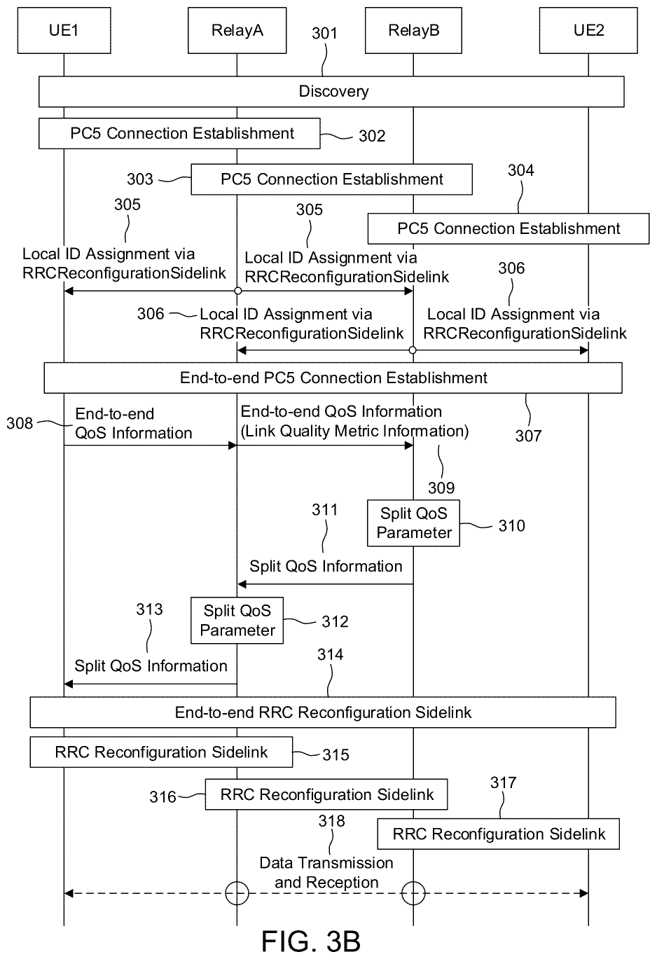

For Layer-2 UE-to-UE Relay, the source U2U Remote UE needs to establish an end-to-end PC5 connection and end-to-end sidelink data radio bearers (SL-DRBs) with the target U2U Remote UE before user plane data transmission. To this end, an example control plane procedure for multihop Layer-2 UE-to-UE Relay to facilitate the proposed solutions is shown in FIG. 3A.

UE1 (source U2U Remote UE), U2U RelayA UE, U2U RelayB UE, and UE2 (target U2U Remote UE) may perform a discovery procedure or an integrated discovery procedure 301.

UE1 may establish/modify a PC5 connection 302 with U2U RelayA UE using, for example, DCR/LMR and DCA/LMA messages. U2U RelayA UE may establish/modify a PC5 connection 303 with U2U RelayB UE using, for example, DCR/LMR and DCA/LMA messages. U2U RelayB UE may establish/modify a PC5 connection 304 with UE2 (target U2U Remote UE) using, for example, DCR/LMR and DCA/LMA messages. Note that the sequence of steps 302, 302, and 304 is a simplified illustration of the hop-by-hop DCR/LMR and DCA/LMA message exchange sequence described with regard to FIG. 2).

U2U RelayA UE may allocate two local UE IDs 305 and deliver/send them to UE1 (source U2U Remote UE) and U2U RelayB UE via, for example, RRCReconfigurationSidelink messages. One local UE ID may identify the source U2U Remote UE (here, source UE IDa), and the other local UE ID may identify the target U2U Remote UE (here, target UE IDa). When the pair of local UE IDs (here, [source UE IDa, target UE IDa]) is delivered, a pair of Layer-2 IDs (here, [source Layer-2 ID, target Layer-2 ID]) received from a ProSe layer is also delivered for making an association between the local UE ID and Layer-2 ID of the source/target U2U Remote UE. The Layer-2 ID of the source U2U Remote UE may be omitted in the RRCReconfigurationSidelink message sent to UE1. The source and target Layer-2 IDs may be termed the E2E source and E2E target Layer-2 IDs in this disclosure.

U2U RelayB UE may allocate two local UE IDs 306 and deliver/send them to U2U RelayA UE and UE2 (target U2U Remote UE) via, for example, RRCReconfigurationSidelink messages. One local UE ID may identify the source U2U Remote UE (here, source UE IDb), and the other local UE ID may identify the target U2U Remote UE (here, target UE IDb). When the pair of local UE IDs (here, [source UE IDb, target UE IDb]) is delivered, a pair of Layer-2 IDs (here, [source Layer-2 ID, target Layer-2 ID]) received from a ProSe layer is also delivered for making an association between the local UE ID and Layer-2 ID of the source/target U2U Remote UE. The Layer-2 ID of the target U2U Remote UE may be omitted in the RRCReconfigurationSidelink message send to UE2. The source and target Layer-2 IDs may be termed the E2E source and E2E target Layer-2 IDs in this disclosure.

UE1 (source U2U Remote UE) may establish an end-to-end PC5 connection 307 with UE2 (target U2U Remote UE) using end-to-end Direct Communication Request (e2e DCR) and end-to-end Direct Communication Accept (e2e DCA) messages, via U2U RelayA UE and U2U RelayB UE. For the end-to-end link establishment/connection setup, fixed indexes (i.e., 0/1/2/3) may be defined for end-to-end Sidelink Signaling Radio Bearer (SL-SRB) 0/1/2/3 respectively, and specified PC5 Relay radio link control (RLC) channel configuration (e.g., SL-U2U-RLC) may be used on each hop.

UE1 may send to U2U RelayA UE the quality of service (QoS) profiles for end-to-end QoS flows 308 via, for example, a UEInformationRequestSidelink message.

U2U RelayA UE may perform QoS split (e.g., for packet delay budget (PDB)) into QoS 309 between UE1 and U2U RelayA UE and QoS between U2U RelayA UE and UE2, considering, for example, a number of hops and/or per PC5 hop link quality metric information. PC5 hop link metric information between U2U RelayB UE and UE2 (target U2U Remote UE) may be provided in the DCA/LMA message sent to U2U RelayA UE during multihop PC5 link establishment/connection setup.

U2U RelayA UE may send to U2U RelayB UE the QoS profiles 310 between U2U RelayA UE and UE2 for end-to-end QoS flows via, for example, a UEInformationRequestSidelink message.

U2U RelayB UE may perform QoS split (e.g., for PDB) into QoS 311 between U2U RelayA UE and U2U RelayB UE and QoS between U2U RelayB UE and UE2.

U2U RelayB UE may send the split QoS value (e.g., for PDB) 312 between U2U RelayA UE and U2U RelayB UE via, for example, a UEInformationResponseSidelink message to U2U RelayA UE.

U2U RelayA UE may send the split QoS value (e.g., for PDB) 313 between UE1 and U2U RelayA UE via, for example, a UEInformationResponseSidelink message to UE1.

UE1 (source U2U Remote UE) or the serving gNB of UE1 may derive the Packet Data Convergence Protocol (PDCP) and Service Data Adaptation Protocol (SDAP) configuration for an end-to-end SL-DRB and may provide the portion of the configuration related to reception to UE2 (target U2U Remote UE) 314 using, for example, end-to-end RRCReconfigurationSidelink messages. The end-to-end bearer IDs for SL-SRB and SL-DRB may be used as input for the L2 U2U Relay ciphering and deciphering at PDCP.

UE1 or the serving gNB of UE1 may derive the first hop configuration (e.g. PC5 Relay RLC channel configuration) for a SL-DRB and may provide to U2U RelayA UE the configuration related to receiving on the first hop 315 (i.e., received by U2U RelayA UE), using, for example, a per-hop RRCReconfigurationSidelink message.

U2U RelayA UE or the serving gNB of U2U RelayA UE may derive the second hop configuration (e.g. PC5 Relay RLC channel configuration) for each SL-DRB and may provide to U2U RelayB UE the configuration related to receiving data packets on the second hop 316 (i.e., received by U2U RelayB UE), using, for example, a per-hop RRCReconfigurationSidelink message.

U2U RelayB UE or the serving gNB of U2U RelayB UE may derive the third hop configuration (e.g. PC5 Relay RLC channel configuration) for each SL-DRB and may provide to UE2 the configuration related to receiving data packets on the third hop 317 (i.e., received by the target U2U Remote UE), using, for example, a per-hop RRCReconfigurationSidelink message.

UE1and UE2may transmit or receive data 318 via U2U RelayA UE and U2U RelayB UE.

FIG. 3B shows an alternative example of a multihop Layer-2 UE-to-UE Relay link establishment/connection setup procedure. The following alternative QoS split approach incorporating link quality metric information may also be used. Only steps related to the alternative QoS split are described with regard to FIG. 3B.

UE1 may send to U2U RelayA UE the QoS profiles for end-to-end QoS flows 308 U2U RelayA UE may provide/send a link quality metric between UE1 and U2U RelayA UE to U2U RelayB UE, in addition to the QoS profiles for end-to-end QoS flows 309.

U2U RelayB UE may perform QoS split 310 between UE1 and U2U RelayB UE, and between U2U RelayB UE and UE2, considering per PC5 hop link quality metric information.

U2U RelayB UE may send the split QoS value (e.g., for PDB) 311 between UE1 and U2U RelayB UE to U2U RelayA UE.

U2U RelayA UE may perform QoS split 312 between UE1 and U2U RelayA UE, and between U2U RelayA UE and U2U RelayB UE.

U2U RelayA UE may sends the split QoS value (e.g., for PDB) 313 between UE1 and U2U RelayA UE to UE1.

This disclosure proposes 3GPP Rel-18 backward compatible approaches to perform Layer-2 Routing in a UE-to-UE Relay mesh network, which is distinct from the conventional routing-protocol based methodology in the following main aspects. Each UE in the UE-to-UE Relay mesh network does not have a globally unique L2 routing address. Each U2U Relay UE allocates its own set of locally unique SRAP UE IDs for the source/target U2U remote UEs. A UE acting as a U2U Relay does not need to be assigned a local UE ID. Each U2U Relay UE only needs to know the source/target UE IDs allocated by its neighbor U2U Relay UEs to facilitate the end-to-end routing between the source U2U Remote UE and target U2U Remote UE. Source/target UE ID swapping is performed between neighbor U2U Relay UEs as needed.

Layer-2 routing is based on the coordination between a ProSe layer and an AS layer. There is no AS layer routing protocol message exchange to set up a L2 Relay Routing Table. Th ProSe layer performs UE-to-UE Relay discovery and link establishment/connection setup. The ProSe layer provides a number of hops and next-hop Layer-2 IDs to the source and target U2U Remote UEs to the AS layer to facilitate L2 Relay Routing Table setup. In addition, the ProSe layer provides E2E source Layer-2 ID and E2E target Layer-2 ID to the AS layer. Source/target UE IDs are allocated at the AS layer associated with the E2E source/target Layer-2 IDs provided from ProSe layer.

In a first embodiment, E2E source and E2E target layer-2 IDs may be allocated. In 3GPP Release 18, after local UE IDs of the source/target U2U Remote UEs are allocated by the U2U Relay UE, the pair of allocated local UE IDs and Layer-2 ID of the target U2U Remote UE are provided to the source U2U Remote UE, and the pair of allocated local UE IDs and Layer-2 ID of source U2U Remote UE are provided to the target U2U Remote UE using the RRCReconfigurationSidelink messages, for making the association between the local UE ID and Layer-2 ID. However, since the Layer-2 ID of the source U2U Remote UE is self-selected by the source U2U Remote UE and the Layer-2 ID of the target U2U Remote UE is self-selected by the target U2U Remote UE, and each U2U Relay UE may only detect Layer-2 ID conflicts within its immediate hop, Layer-2 ID uniqueness beyond an immediate hop cannot be guaranteed in the case of multihop Layer-2 UE-to-UE Relay with two or more U2U Relay UEs, which may lead to ambiguity in multihop Layer-2 routing.

To mitigate this issue, this embodiment describes an E2E Layer-2 ID allocation and deconfliction procedure such that on each node along the end-to-end path, every pair of [E2E source Layer-2 ID, E2E target Layer-2 ID] may uniquely identify an end-to-end link terminated by or passing through that node.

Before starting a multihop PC5 connection setup procedure, the source U2U Remote UE may self-select a locally unique E2E source Layer-2 ID (i.e., not in conflict with E2E source Layer-2 IDs already associated with other end-to-end links terminated by or passing through the source U2U Remote UE) and a locally unique E2E target Layer-2 ID associated with the self-selected E2E source Layer-2 ID, and may store the mapping or association between the self-selected [E2E source Layer-2 ID, E2E target Layer-2 ID] and [source User Info ID, target User Info ID]. The source U2U Remote UE may reuse a previously selected E2E source Layer-2 ID or select a new one. Each pair of [E2E source Layer-2 ID, E2E target Layer-2 ID] may uniquely identify an end-to-end link (i.e., associated with a unique pair of [source User Info ID, target User Info ID]) terminated by or passing through the source U2U Remote UE. In general, the E2E source Layer-2 ID and E2E target Layer-2 ID are logical Layer-2 IDs. Conflict between E2E source/target Layer-2 IDs and source/destination Layer-2 IDs used for transmission or reception in the AS layer is not an issue.

During the multihop PC5 connection setup, the source U2U Remote UE may include the pair of [E2E source Layer-2 ID, E2E target Layer-2 ID] in a Direct Communication Request (DCR) or Link Modification Request (LMR) message sent to the U2U RelayA UE.

U2U RelayA UE may store the mapping between [E2E source Layer-2 ID, E2E target Layer-2 ID] and [source User Info ID, target User Info ID] based on the information in the DCR/LMR received from the source U2U Remote UE and may include the [E2E source Layer-2 ID, E2E target Layer-2 ID] in a DCR/LMR sent to the U2U RelayB UE. If the same E2E source Layer-2 ID has been previously received from a different source U2U Remote UE (including U2U RelayA UE itself acting as a source U2U Remote UE for other end-to-end links), U2U RelayA UE may include an E2E source Layer-2 ID reallocation indication in the DCR/LMR sent to U2U RelayB UE.

U2U RelayB UE may store the mapping between the [E2E source Layer-2 ID, E2E target Layer-2 ID] and [source User Info ID, target User Info ID] based on the information in the DCR/LMR received from U2U RelayA UE and may include the [E2E source Layer-2 ID, E2E target Layer-2 ID] in a DCR/LMR sent to the target U2U Remote UE. If an E2E source Layer-2 ID reallocation indication has been received in the DCR/LMR from U2U RelayA UE, or if the same E2E source Layer-2 ID has been previously received from a different source U2U Remote UE, or if the same E2E source Layer-2 ID has been previously selected by U2U RelayB UE acting as a source U2U Remote UE for other end-to-end links, U2U RelayB UE may include an E2E source Layer-2 ID reallocation indication in the DCR/LMR sent to the target U2U Remote UE.

The target U2U Remote UE may store the mapping between [E2E source Layer-2 ID, E2E target Layer-2 ID] and [source User Info ID, target User Info ID] based on the information in the DCR/LMR received from U2U RelayB UE and may send a Direct Communication Accept (DCA) or Link Modification Accept (LMA) message to U2U RelayB UE. If an E2E source Layer-2 ID reallocation indication has been received in the DCR/LMR from U2U RelayB UE, or if the same E2E source Layer-2 ID has been previously received from a different source U2U Remote UE, or if the same E2E source Layer-2 ID has been previously selected by the target U2U Remote UE acting as a source U2U Remote UE for other end-to-end links, the target U2U Remote UE may include an E2E source Layer-2 ID reallocation indication in the DCA/LMA sending to U2U RelayB UE. In addition, the target U2U Remote UE may include a list of allocated E2E source Layer-2 IDs already allocated by itself or other source U2U Remote UEs with the associated end-to-end links terminated by or passing through the target U2U Remote UE in the DCA/LMA sent to U2U RelayB UE.

U2U RelayB UE may send a DCA or LMA message to U2U RelayA UE. If an E2E source Layer-2 ID reallocation indication has been received in the DCA/LMA from the target U2U Remote UE, U2U RelayB UE may include an E2E source Layer-2 ID reallocation indication in the DCA/LMA sent to U2U RelayA UE. In addition, U2U RelayB UE may add the source Layer-2 IDs already allocated by itself or other source U2U Remote UEs with the associated end-to-end links terminated by or passing through U2U RelayB UE to the received list of allocated E2E source Layer-2 IDs in the DCA/LMA sent to U2U RelayA UE.

U2U RelayA UE may send a DCA or LMA message to the source U2U Remote UE. If an E2E source Layer-2 ID reallocation indication has been received in the DCA/LMA from U2U RelayB UE, U2U RelayA UE may include an E2E source Layer-2 ID reallocation indication in the DCA/LMA sent to the source U2U Remote UE. In addition, U2U RelayA UE may add the source Layer-2 IDs already allocated by itself or other source U2U Remote UEs with the associated end-to-end links terminated by or passing through U2U RelayA UE to the received list of allocated E2E source Layer-2 IDs in the DCA/LMA sent to the source U2U Remote UE.

If the source U2U Remote UE receives an E2E source Layer-2 ID reallocation indication in the DCA/LMA, the source U2U Remote UE may reselect another locally unique E2E source Layer-2 ID that does not overlap with the list of allocated E2E source Layer-2 IDs received in DCA/LMA.

The source U2U Remote UE may send the reselected E2E source Layer-2 ID to the target U2U Remote UE hop by hop via, for example, a Link Modification Request (LMR) message and the target U2U Remote UE may confirm the E2E source Layer-2 ID reselection via, for example, hop-by-hop via a Link Modification Accept (LMA) message, which may include the reselected E2E source Layer-2 ID. Upon sending the LMA message to confirm the reselected E2E source Layer-2 ID, the target U2U Remote UE may update the mapping between [E2E source Layer-2 ID, E2E target Layer-2 ID] and [source User Info ID, target User Info ID]. Upon receiving the LMA message, the U2U Relay UEs and the source U2U Remote UE may update the mapping between [E2E source Layer-2 ID, E2E target Layer-2 ID] and [source User Info ID, target User Info ID].

If E2E source Layer-2 ID reselection is not required, or after E2E source Layer-2 ID reselection, the E2E source Layer-2 ID of the source U2U Remote UE should not be in conflict with any E2E source Layer-2 IDs associated with end-to-end links terminated by or passing through the source U2U Remote UE, the target U2U Remote UE, and each U2U Relay UE along the end-to-end path. As a result, on each node along the end-to-end path, an E2E source Layer-2 ID may uniquely identify a source U2U Remote UE with an end-to-end link terminated by or passing through that node.

In addition, since the E2E target Layer-2 ID is locally unique with respect to each E2E source Layer-2 ID, the pair of [E2E source Layer-2 ID, E2E target Layer-2 ID] may uniquely identify an end-to-end link (e.g., associated with a unique pair of [source User Info ID, target User Info ID]) on each node (i.e., the source U2U Remote UE, the target U2U Remote UE or any U2U Relay UE) along the end-to-end path.

On the other hand, this does not mean the pair of [E2E source Layer-2 ID, E2E target Layer-2 ID] may uniquely identify a pair of [source User Info ID, target User Info ID] in the whole UE-to-UE Relay mesh network. It is still possible that two parallel end-to-end paths between two pairs of source and target U2U Remote UEs are assigned the same pair of [E2E source Layer-2 ID, E2E target Layer-2 ID] without being detected. Since these two paths do not intercept, multihop Layer-2 UE-to-UE relay may be performed on each path without affecting the other path.

In an example, the E2E target Layer-2 ID may be reallocated, instead of the E2E source Layer-2 ID. During multihop PC5 connection setup, the source U2U Remote UE may self-select a locally unique E2E source Layer-2 ID and a locally unique E2E target Layer-2 ID associated with the self-selected E2E source Layer-2 ID, which may be included in the DCR/LMR message sent to the target U2U Remote UE via U2U RelayA UE and U2U RelayB UE.

If the same [E2E source Layer-2 ID, E2E target Layer-2 ID] pair has been previously received from a different source U2U Remote UE on a U2U Relay UE along the connection setup path (including the U2U Relay UE itself acting as a source U2U Remote UE for other end-to-end links), the U2U Relay UE may include an E2E target Layer-2 ID reallocation indication in the DCR/LMR message sent to the target U2U Remote UE. All downstream U2U Relay UEs may also include an E2E target Layer-2 ID reallocation indication when sending the DCR/LMR message to the next hop.

If an E2E target Layer-2 ID reallocation indication has been received by the target U2U Remote UE in the DCR/LMR message, or if the same [E2E source Layer-2 ID, E2E target Layer-2 ID] pair has been previously received from a different source U2U Remote UE (including the target U2U Remote UE itself acting as a source U2U Remote UE for other end-to-end links), the target U2U Remote UE and U2U Relay UEs along the connection setup path may include an E2E target Layer-2 ID reallocation indication in the DCA/LMA message sent to the source U2U Remote UE. In addition, the target U2U Remote UE or any U2U Relay UE with conflicting [E2E source Layer-2 ID, E2E target Layer-2 ID] may include/add to a list of allocated E2E target Layer-2 IDs associated with the overlapping E2E source Layer-2 ID in the DCA/LMA message sent to the source U2U Remote UE. The source U2U Remote UE may send a reselected non-conflicting E2E target Layer-2 ID to the target U2U Remote UE via a LMR and the target U2U Remote UE may confirm the reselected E2E target Layer-2 ID via a LMA.

In an example, the solutions disclosed in U.S. application Ser. No. 18/905,640 may be used as alternative approaches to resolve E2E source and/or target Layer-2 ID conflict.

In a second embodiment, Layer-2 (L2) routing may be based on SRAP source and destination UE IDs. For multihop Layer-2 UE-to-UE Relay with a pair of U2U Remote UEs and two or more U2U Relay UEs, solutions are needed to address the following: (i) Which UE(s) is(are) responsible for allocating local UE IDs, which UEs need to be allocated local UE IDs, and how to disseminate the allocated local UE IDs for multihop Layer-2 UE-to-UE Relay communication? (ii) How to determine the egress link and the source and destination UE IDs in the egress SRAP header on each UE, based on the source and destination UE IDs in the ingress SRAP header?

This embodiment describes a distributed local UE ID allocation procedure, a procedure to set up the L2 Relay Routing Table for egress link determination, and a procedure to set up the UE ID Mapping Table for determination of the egress source and destination UE IDs.

For the distributed local UE ID allocation procedure, each U2U Relay UE may allocate two local UE IDs: one local UE ID for E2E source Layer-2 ID to identify the source U2U Remote UE and the other local UE ID for E2E target Layer-2 ID to identify the target U2U Remote UE. The E2E source Layer-2 ID and the E2E target Layer-2 ID may be obtained or determined from embodiment one described above. Alternatively, the E2E source Layer-2 ID and the E2E target Layer-2 ID may be the Layer-2 ID of the source U2U Remote UE and the Layer-2 ID of the target U2U Remote UE respectively.

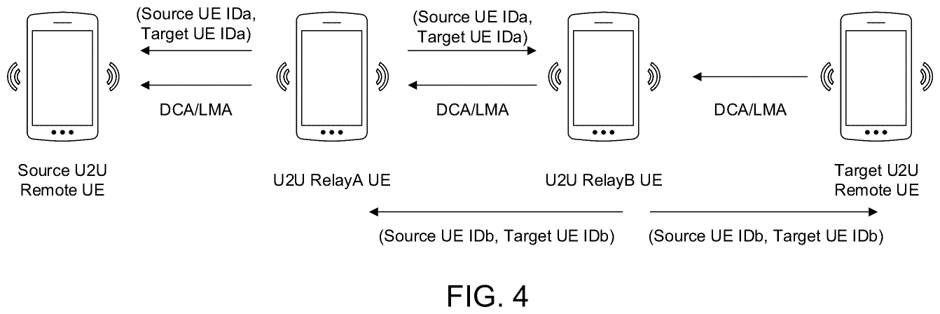

FIG. 4 shows an example of local UE ID allocation and neighbor notification for multihop Layer-2 UE-to-UE Relay.

After sending the DCA/LMA without an E2E source Layer-2 ID reallocation indication or LMA with confirmation of the reselected E2E source Layer-2 ID, the ProSe layer of the target U2U Remote UE may send [E2E source Layer-2 ID, E2E target Layer-2 ID] to the AS layer to identify the end-to-end link. In addition, the ProSe layer of the target U2U Remote UE may provide the source Layer-2 ID of U2U RelayB UE (e.g., associated with the received Direct Security Mode (DSM) Complete message during security establishment with U2U RelayB UE after receiving DCR from U2U RelayB UE) as the next-hop Layer-2 ID to the source U2U Remote UE, for the associated [E2E source Layer-2 ID, E2E target Layer-2 ID], and a number of hops to the source U2U Remote UE (here, 3), to the AS layer.

After receiving the DCA/LMA without an E2E source Layer-2 ID reallocation indication or LMA with confirmation of a reselected E2E source Layer-2 ID from the target U2U Remote UE, the ProSe layer of U2U RelayB UE may send [E2E source Layer-2 ID, E2E target Layer-2 ID] to the AS layer to identify the end-to-end link. In addition, the ProSe layer of U2U RelayB UE may provide the source Layer-2 ID of U2U RelayA UE (e.g., associated with the received DSM Complete message during security establishment with U2U RelayA UE after receiving DCR from U2U RelayA UE) as the next-hop Layer-2 ID to the source U2U Remote UE and the source Layer-2 ID of the target U2U Remote UE (e.g., associated with the received DCA/LMA message from the target U2U Remote UE) as the next-hop Layer-2 ID to the target U2U Remote UE, for the associated [E2E source Layer-2 ID, E2E target Layer-2 ID], and a number of hops to the source and target U2U Remote UEs (here, 2 to the source; 1 to the target, i.e., directly connected), to the AS layer.

After receiving the DCA/LMA without an E2E source Layer-2 ID reallocation indication or LMA with confirmation of the reselected E2E source Layer-2 ID from U2U RelayB UE, the ProSe layer of U2U RelayA UE may send [E2E source Layer-2 ID, E2E target Layer-2 ID] to the AS layer to identify the end-to-end link. In addition, the ProSe layer of U2U RelayA UE may provide the source Layer-2 ID of the source U2U Remote UE (e.g., associated with the received DSM Complete message during security establishment with the source U2U Remote UE after receiving DCR from the source U2U Remote UE) as the next-hop Layer-2 ID to the source U2U Remote UE and the source Layer-2 ID of the U2U RelayB UE (e.g., associated with the received DCA/LMA message from U2U RelayB UE) as the next-hop Layer-2 ID to the target U2U Remote UE, for the associated [E2E source Layer-2 ID, E2E target Layer-2 ID], and a number of hops to the source and target U2U Remote UEs (here, 1 to the source, i.e., directly connected; 2 to the target), to the AS layer.

After receiving the DCA/LMA without an E2E source Layer-2 ID reallocation indication or LMA with confirmation of the reselected E2E source Layer-2 ID from U2U RelayA UE, the ProSe layer of the source U2U Remote UE may send [E2E source Layer-2 ID, E2E target Layer-2 ID] to the AS layer to identify the end-to-end link. In addition, the ProSe layer of the source U2U Remote UE may provide the source Layer-2 ID of U2U RelayA UE (e.g., associated with the received DCA/LMA message from U2U RelayA UE) as the next-hop Layer-2 ID to the target U2U Remote UE, for the associated [E2E source Layer-2 ID, E2E target Layer-2 ID], and a number of hops to the target U2U Remote UE (here, 3), to the AS layer.

The AS layer of U2U RelayA UE may allocate one local UE ID for the E2E source Layer-2 ID (here, source UE IDa) and one local UE ID for the E2E target Layer-2 ID (here, target UE IDa). If the number of hops to the source U2U Remote UE=1 (here, source Layer-2 ID of the source U2U Remote UE=next-hop Layer-2 ID to the source U2U Remote UE received from ProSe layer), the AS layer of U2U RelayA UE may add the following entry to a (Previous-hop and/or Next-hop) UE ID Mapping Table. For a Previous-hop UE ID Mapping Table (in support of the third embodiment described below), the entry may include: Previous-hop Layer-2 ID: [source Layer-2 ID of the source U2U Remote UE]; Ingress UE IDs: [source UE IDa, target UE IDa]; and/or Egress UE IDs: [source UE IDa, target UE IDa]. For a Next-hop UE ID Mapping Table (in support of the fourth embodiment describe below) , the entry may include: Next-hop Layer-2 ID: [source Layer-2 ID of the source U2U Remote UE]; Ingress UE IDs: [target UE IDa, source UE IDa]; and Egress UE IDs: [target UE IDa, source UE IDa].

The AS layer of U2U RelayA UE may store the entry from the source to the target U2U Remote UE in the L2 Relay Routing Table. The entry may include: Source UE ID: source UE IDa; Destination UE ID: target UE IDa; Number of Hops to Destination: 2; and/or Next Hop Layer-2 ID: source Layer-2 ID of U2U RelayB UE.

The AS layer of U2U RelayA UE may stores the entry from the target to the source U2U Remote UE in the L2 Relay Routing Table. The entry may include: Source UE ID: target UE IDa; Destination UE ID: source UE IDa; Number of Hops to Destination: 1 (directly connected); and/or Next Hop Layer-2 ID: source Layer-2 ID of the source U2U Remote UE.

The AS layer of U2U RelayB UE may allocate one local UE ID for the E2E source Layer-2 ID (here, source UE IDb) and one local UE ID for the E2E target Layer-2 ID (here, target UE IDb). If the number of hops to the target U2U Remote UE=1 (here, source Layer-2 ID of the target U2U Remote UE=next-hop Layer-2 ID to the target U2U Remote UE received from ProSe layer), the AS layer of U2U RelayB UE may add the following entry to a (Previous-hop and/or Next-hop) UE ID Mapping Table. For a Previous-hop UE ID Mapping Table (in support of the third embodiment described below), the entry may include: Previous-hop Layer-2 ID: [source Layer-2 ID of the target U2U Remote UE]; Ingress UE IDs: [target UE IDb, source UE IDb]; and/or Egress UE IDs: [target UE IDb, source UE IDb]. For a Next-hop UE ID Mapping Table (in support of the fourth embodiment described below), the entry may include: Next-hop Layer-2 ID: [source Layer-2 ID of the target U2U Remote UE]; Ingress UE IDs: [source UE IDb, target UE IDb]; and/or Egress UE IDs: [source UE IDb, target UE IDb].

The AS layer of U2U RelayB UE may store the entry from the source to the target U2U Remote UE in the L2 Relay Routing Table. The entry may include: Source UE ID: source UE IDb; Destination UE ID: target UE IDb; Number of Hops to Destination: 1 (directly connected); and/or Next Hop Layer-2 ID: source Layer-2 ID of the target U2U Remote UE

The AS layer of U2U RelayB UE may store the entry from the target to the source U2U Remote UE in the L2 Relay Routing Table. The entry may include: Source UE ID: target UE IDb; Destination UE ID: source UE IDb; Number of Hops to Destination: 2; and/or Next Hop Layer-2 ID: source Layer-2 ID of U2U RelayA UE.

The AS layer of U2U RelayA UE may send the locally assigned [source UE IDa, target UE IDa] and the associated [E2E source Layer-2 ID, E2E target Layer-2 ID] in, for example, RRCReconfigurationSidelink messages to the source U2U Remote UE and U2U RelayB UE.

The AS layer of U2U RelayB UE may send the locally assigned [source UE IDb, target UE IDb] and the associated [E2E source Layer-2 ID, E2E target Layer-2 ID] in, for example, RRCReconfigurationSidelink messages to U2U RelayA UE and the target U2U Remote UE.

After receiving the RRCReconfigurationSidelink message from U2U RelayA UE, which may include [source UE IDa, target UE IDa] and [E2E source Layer-2 ID, E2E target Layer-2 ID], the AS layer of the source U2U Remote UE may store the mapping or association between [E2E source Layer-2 ID, E2E target Layer-2 ID] and [source UE IDa, target UE IDa]. The AS layer of the source U2U Remote UE may store the route entry from the source to the target U2U Remote UE in the L2 Relay Routing Table. The entry may include: Source UE ID: source UE IDa; Destination UE ID: target UE IDa; Number of Hops to Destination: 3; Next Hop Layer-2 ID: source Layer-2 ID of U2U RelayA UE.

After receiving the RRCReconfigurationSidelink message from U2U RelayB UE, which may include [source UE IDb, target UE IDb] and [E2E source Layer-2 ID, E2E target Layer-2 ID], the AS layer of U2U RelayA UE may add the following entry to a (Previous-hop and/or Next-hop) UE ID Mapping Table based on the association with [E2E source Layer-2 ID, E2E target Layer-2 ID]. If the source Layer-2 ID of U2U RelayB UE=next-hop Layer-2 ID to the target U2U Remote UE, the Previous-hop UE ID Mapping Table (in support of the third embodiment described below) may include: Previous-hop Layer-2 ID: [source Layer-2 ID of U2U RelayB UE]; Ingress UE IDs: [target UE IDb, source UE IDb]; and/or Egress UE IDs: [target UE IDa, source UE IDa]. The Next-hop UE ID Mapping Table (in support of the fourth embodiment described below) may include: Next-hop Layer-2 ID: [source Layer-2 ID of U2U RelayB UE]; Ingress UE IDs: [source UE IDa, target UE IDa]; and/or Egress UE IDs: [source UE IDb, target UE IDb].

After receiving the RRCReconfigurationSidelink message from U2U RelayA UE, which may include [source UE IDa, target UE IDa] and [E2E source Layer-2 ID, E2E target Layer-2 ID], the AS layer of U2U RelayB UE may add the following entry to a (Previous-hop and/or Next-hop) UE ID Mapping Table based on the association with [E2E source Layer-2 ID, E2E target Layer-2 ID]. If the source Layer-2 ID of U2U RelayA UE=next-hop Layer-2 ID to the source U2U Remote UE, the Previous-hop UE ID Mapping Table (in support of the third embodiment described below) may include: Previous-hop Layer-2 ID: [source Layer-2 ID of U2U RelayA UE]; Ingress UE IDs: [source UE IDa, target UE IDa]; and/or Egress UE IDs: [source UE IDb, target UE IDb]. The Next-hop UE ID Mapping Table (in support of the fourth embodiment described below) may include: Next-hop Layer-2 ID: [source Layer-2 ID of U2U RelayA UE]; Ingress UE IDs: [target UE IDb, source UE IDb]; and/or Egress UE IDs: [target UE IDa, source UE IDa].

After receiving the RRCReconfigurationSidelink message from U2U RelayB UE, which may include [source UE IDb, target UE IDb] and [E2E source Layer-2 ID, E2E target Layer-2 ID], the AS layer of the target U2U Remote UE may store the mapping between [E2E source Layer-2 ID, E2E target Layer-2 ID] and [source UE IDb, target UE IDb]. The AS layer of the target U2U Remote UE may store the route entry from the target to the source U2U Remote UE in the L2 Relay Routing Table. The entry may include: Source UE ID: target UE IDb; Destination UE ID: source UE IDb; Number of Hops to Destination: 3; and/or Next Hop Layer-2 ID: source Layer-2 ID of U2U RelayB UE.

In an example, the ProSe layer may also send the source/target User Info IDs to the AS layer. In this case, the following may be performed. During multihop PC5 connection setup, the ProSe layer of each U2U Relay UE may provide the number of hops and next-hop Layer-2 ID to the source U2U Remote UE, and the number of hops and next-hop Layer-2 ID to the target U2U Remote UE, as well as the mapping between [E2E source Layer-2 ID, target Layer-2 ID] and [source User Info ID, target User Info ID] to AS layer. U2U RelayA UE may allocate one local UE ID for the source User Info ID and one local UE ID for the target User Info ID and may send the assigned source/target UE IDs and corresponding E2E source/target Layer-2 IDs to the source U2U Remote UE and U2U RelayB UE. U2U RelayB UE may allocate one local UE ID for the source User Info ID and one local UE ID for the target User Info ID and may send the assigned source/target UE IDs and corresponding E2E source/target Layer-2 IDs to the target U2U Remote UE and U2U RelayA UE. The U2U Relay UEs may set up route entries to the source and target U2U Remote UEs in the L2 Relay Routing Table for egress link determination. Here, since the Application Layer User Info IDs may be assumed to be unique, only the Destination UE ID is needed in the L2 Relay Routing Table. For example, U2U RelayA UE route entry to the target U2U Remote UE in the L2 Relay Routing Table may include: Destination UE ID: target UE IDa; Number of Hops to Destination: 2; and/or Next Hop Layer-2 ID: source Layer-2 ID of U2U RelayB UE.

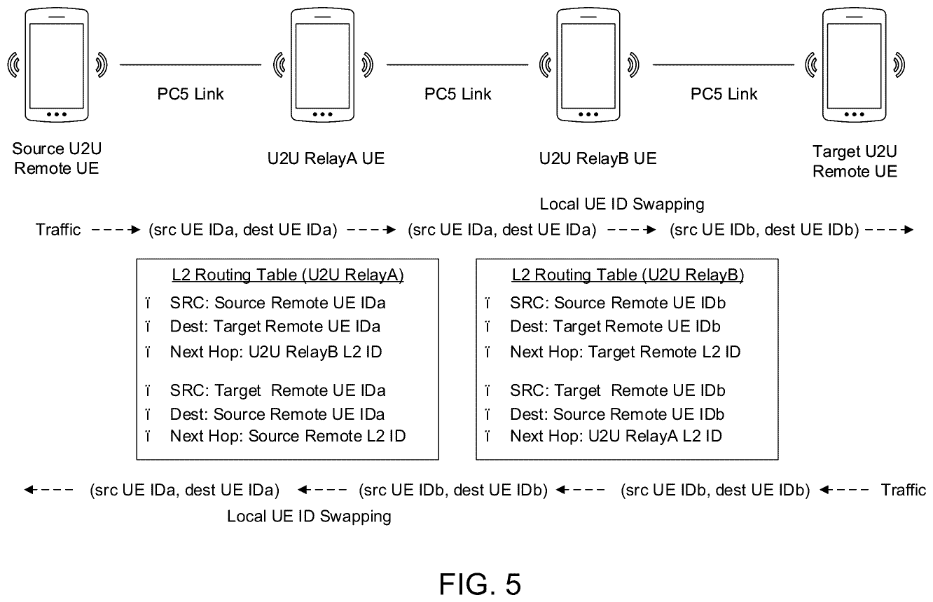

In a third embodiment, layer-2 routing may be performed with local UE ID swapping before egress link determination. FIG. 5 shows an example procedure of a U2U relay UE using local UE IDs allocated by itself for egress traffic.

In the third embodiment, Layer-2 (L2) routing may be performed with local UE ID swapping before egress link determination. For multihop Layer-2 UE-to-UE (U2U) Relay with a pair of U2U Remote UEs and two or more U2U Relay UEs, solutions are needed to address how to perform end-to-end L2 Routing based on the local UE IDs that are independently allocated by each U2U Relay UE along the end-to-end path.

This embodiment describes an end-to-end L2 Routing procedure based on the hop-by-hop independently allocated local UE IDs by each U2U Relay UE. On each U2U Relay along the end-to-end path, this embodiment first maps or associates the set of source and destination UE IDs in the ingress SRAP header to a set of source and destination UE IDs to be used in the egress SRAP header and then determines the egress link based on the source and destination UE IDs to be used in the egress SRAP header:

A U2U Remote UE may send SRAP data using local UE IDs allocated by its next hop U2U Relay UE in the egress SRAP header.

If the previous hop is a U2U Remote UE, a U2U Relay UE receives SRAP data from the previous hop with local UE IDs allocated by itself. Otherwise, a U2U Relay UE receives SRAP data from the previous hop U2U Relay UE with local UE IDs allocated by the previous hop. If the previous hop is a U2U Remote UE, a U2U Relay UE may use the local UE IDs allocated by itself in the received SRAP header for the egress SRAP header. Otherwise, a U2U Relay UE may perform local UE ID swapping from the local UE IDs allocated by the previous hop in the received SRAP header to the local UE IDs allocated by itself for the egress SRAP header. A U2U Relay UE may determine the egress link to the next hop based on the local UE IDs allocated by itself and its L2 Relay Routing Table and may send SRAP data to the next hop (U2U Remote UE or U2U Relay UE) using local UE IDs allocated by itself. A U2U Remote UE may receive SRAP data with local UE IDs allocated by its previous hop U2U Relay UE.

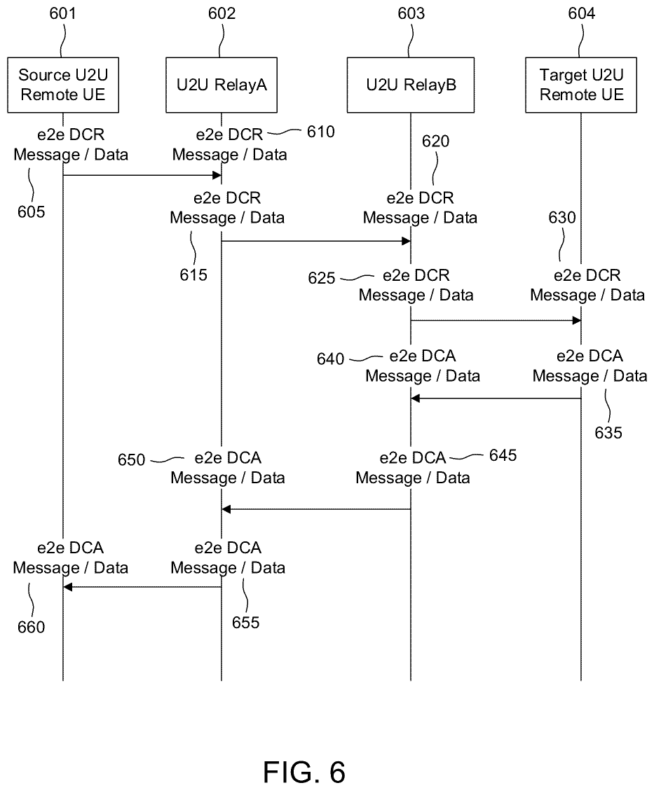

FIG. 6 shows an example procedure of the third embodiment of a U2U relay UE using local UE IDs allocated by itself for egress traffic.

The source U2U Remote UE 601 may send an end-to-end Direct Communication Request (e2e DCR) message for end-to-end PC5 link establishment/connection setup or data traffic 605 to the target U2U Remote UE via U2U RelayA UE 602. The ProSe layer of the source U2U Remote UE may provide [E2E source Layer-2 ID, E2E target Layer-2 ID] to the AS layer. The AS layer of the source U2U Remote UE may determine the [source UE ID, destination UE ID] in the egress SRAP header based on a mapping or association between [E2E source Layer-2 ID, E2E target Layer-2 ID] and the local UE IDs allocated by U2U RelayA UE (here, [source UE IDa, target UE IDa]). The AS layer of the source U2U Remote UE may determine the egress link based on the next-hop Layer-2 ID in a L2 Relay Routing Table entry corresponding to [source UE ID, destination UE ID]=[source UE IDa, target UE IDa], where: Source UE ID: source UE IDa; Destination UE ID: target UE IDa; Number of Hops to Destination: 3; and/or Next Hop Layer-2 ID: source Layer-2 ID of U2U RelayA UE.

U2U RelayA UE 602 may receive the e2e DCR message or data traffic 610 from the source U2U Remote UE 601, with [source UE ID, destination UE ID] in the SRAP header set to [source UE IDa, target UE IDa].

U2U RelayA UE 602 may send an e2e DCR message or data traffic 615 to U2U RelayB UE 603. The AS layer of U2U RelayA UE may map ingress UE IDs to egress UE IDs based on a Previous-hop UE ID Mapping Table entry with previous-hop Layer-2 ID=source Layer-2 ID of the source U2U Remote UE. The Previous-hop UE ID Mapping Table entry may include: Previous-hop Layer-2 ID: [source Layer-2 ID of the source U2U Remote UE]; Ingress UE IDs: [source UE IDa, target UE IDa]; and/or Egress UE IDs: [source UE IDa, target UE IDa]. The AS layer of U2U RelayA UE may determine the egress link based on the local UE IDs used in the egress SRAP header, and the corresponding next-hop Layer-2 ID in its L2 Relay Routing Table, where: Source UE ID: source UE IDa; Destination UE ID: target UE IDa; Number of Hops to Destination: 2; and/or Next Hop Layer-2 ID: source Layer-2 ID of U2U RelayB UE.

U2U RelayB UE 603 may receive an e2e DCR message or data traffic 620 from U2U RelayA UE 602, with [source UE ID, destination UE ID] in the SRAP header set to [source UE IDa, target UE IDa].

U2U RelayB UE 603 may send an e2e DCR message or data traffic 625 to the target U2U Remote UE 604. The AS layer of U2U RelayB UE may perform local UE ID swapping to use the local UE IDs allocated by itself (here, [source UE IDb, target UE IDb]) as the [source UE ID, destination UE ID] in the egress SRAP header based on the Previous-hop UE ID Mapping Table entry with previous-hop Layer-2 ID=source Layer-2 ID of U2U RelayA UE. The Previous-hop UE ID Mapping Table entry may include: Previous-hop Layer-2 ID: [source Layer-2 ID of U2U RelayA UE]; Ingress UE IDs: [source UE IDa, target UE IDa]; and/or Egress UE IDs: [source UE IDb, target UE IDb]. The AS layer of U2U RelayB UE may determine the egress link based on the next-hop Layer-2 ID in the L2 Relay Routing Table entry corresponding to [source UE ID, destination UE ID]=[source UE IDb, target UE IDb], where: Source UE ID: source UE IDb; Destination UE ID: target UE IDb; Number of Hops to Destination: 1 (directly connected); and/or Next Hop Layer-2 ID: source Layer-2 ID of the target U2U Remote UE.

The target U2U Remote UE 604 may receive the e2e DCR message or data traffic 630 from U2U RelayB UE 603, with [source UE ID, destination UE ID] in the SRAP header set to [source UE IDb, target UE IDb]. When the AS layer of the target U2U Remote UE receives an e2e DCR message or data traffic from the U2U RelayB UE, with previous-hop Layer-2 ID=source Layer-2 ID of U2U RelayB UE and [source UE ID, destination UE ID] in the SRAP header=[source UE IDb, target UE IDb] allocated by U2U RelayB UE for the end-to-end link associated with [E2E source Layer-2 ID, E2E target Layer-2 ID], SRAP sublayer of the target U2U Remote UE passes the received e2e DCR message or data traffic to the corresponding PDCP entity in the PDCP sublayer based on the bearer ID in the SRAP header.

The target U2U Remote UE 604 may send an end-to-end Direct Communication Accept (e2e DCA) message or data traffic 635 to the source U2U Remote UE via U2U RelayB UE 603. The ProSe layer of the target U2U Remote UE may provide [E2E source Layer-2 ID, E2E target Layer-2 ID] to the AS layer. The AS layer of the target U2U Remote UE may determine the [source UE ID, destination UE ID] in the egress SRAP header based on the mapping between [E2E source Layer-2 ID, E2E target Layer-2 ID] and the local UE IDs allocated by U2U RelayB UE (here, [target UE IDb, source UE IDb]). The AS layer of the target U2U Remote UE may determine the egress link based on the next-hop Layer-2 ID in the L2 Relay Routing Table entry corresponding to [source UE ID, destination UE ID]=[target UE IDb, source UE IDb], where: Source UE ID: target UE IDb; Destination UE ID: source UE IDb; Number of Hops to Destination: 3; and/or Next Hop Layer-2 ID: source Layer-2 ID of U2U RelayB UE.

U2U RelayB UE 603 may receive the e2e DCA message or data traffic 640 from the target U2U Remote UE 604, with [source UE ID, destination UE ID] in the SRAP header set to [target UE IDb, source UE IDb].

U2U RelayB UE 603 may send an e2e DCA message or data traffic 645 to U2U RelayA UE 602. The AS layer of U2U RelayB UE may map or associate ingress UE IDs to egress UE IDs based on the Previous-hop UE ID Mapping Table entry with previous-hop Layer-2 ID=source Layer-2 ID of the target U2U Remote UE. The Previous-hop UE ID Mapping Table may include: Previous-hop Layer-2 ID: [source Layer-2 ID of the target U2U Remote UE]; Ingress UE IDs: [target UE IDb, source UE IDb]; and/or Egress UE IDs: [target UE IDb, source UE IDb]. The AS layer of U2U RelayB UE may determine the egress link based on the next-hop Layer-2 ID in the L2 Relay Routing Table entry corresponding to [source UE ID, destination UE ID]=[target UE IDb, source UE IDb], where: Source UE ID: target UE IDb; Destination UE ID: source UE IDb; Number of Hops to Destination: 2; and/or Next Hop Layer-2 ID: source Layer-2 ID of U2U RelayA UE.

U2U RelayA UE 602 may receive the e2e DCA message or data traffic 650 from U2U RelayB UE 603, with [source UE ID, destination UE ID] in the SRAP header set to [target UE IDb, source UE IDb].

U2U RelayA UE 602 may send an e2e DCA message or data traffic 655 to the source U2U Remote UE 601. The AS layer of U2U RelayA UE may perform local UE ID swapping to use the local UE IDs allocated by itself (here, [target UE IDa, source UE IDa]) as the [source UE ID, destination UE ID] in the egress SRAP header based on the Previous-hop UE ID Mapping Table entry with previous-hop Layer-2 ID=source Layer-2 ID of U2U RelayB UE. The Previous-hop UE ID Mapping Table may include: Previous-hop Layer-2 ID: [source Layer-2 ID of U2U RelayB UE]; Ingress UE IDs: [target UE IDb, source UE IDb]; and/or Egress UE IDs: [target UE IDa, source UE IDa]. The AS layer of U2U RelayA UE may determine the egress link based on the next-hop Layer-2 ID in the L2 Relay Routing Table entry corresponding to [source UE ID, destination UE ID]=[target UE IDa, source UE IDa]. The L2 Relay Routing Table may include: Source UE ID: target UE IDa; Destination UE ID: source UE IDa; Number of Hops to Destination: 1 (directly connected); and/or Next Hop Layer-2 ID: source Layer-2 ID of the source U2U Remote UE.

The source U2U Remote UE 601 may receive the e2e DCA message or data traffic 660 from U2U RelayA UE 602, with [source UE ID, destination UE ID] in the SRAP header set to [target UE IDa, source UE IDa]. When the AS layer of the source U2U Remote UE receives the e2e DCA message or data traffic from the U2U RelayA UE, with previous-hop source Layer-2 ID=source Layer-2 ID of U2U RelayA UE and [source UE ID, destination UE ID] in the SRAP header=[target UE IDa, source UE IDa] allocated by U2U RelayA UE for the end-to-end link associated with [E2E source Layer-2 ID, E2E target Layer-2 ID], SRAP sublayer of the source U2U Remote UE passes the received e2e DCA message or data traffic to the corresponding PDCP entity in the PDCP sublayer based on the bearer ID in the SRAP header.

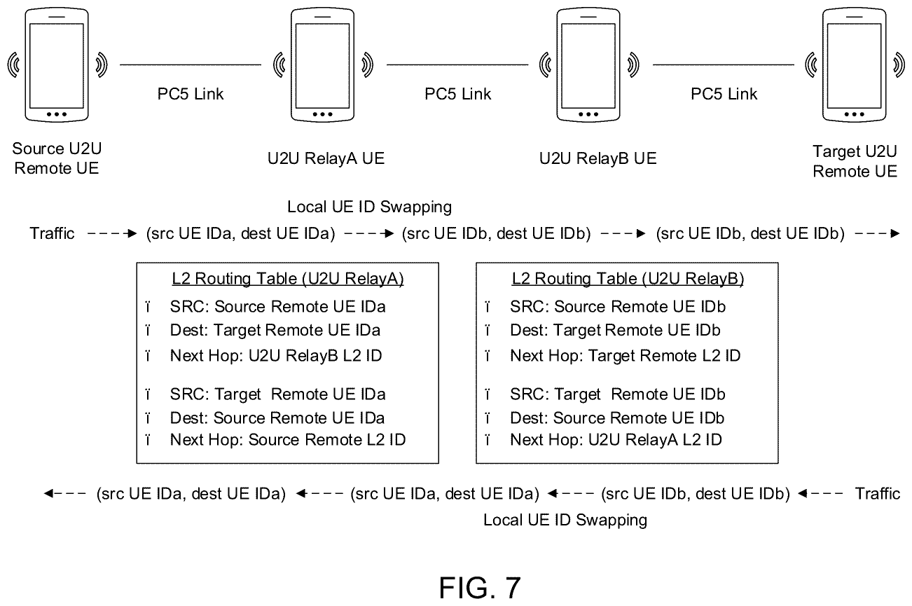

In a fourth embodiment, Layer-2 (L2) routing may be performed with local UE ID swapping after egress link determination. For multihop Layer-2 UE-to-UE Relay with a pair of U2U Remote UEs and two or more U2U Relay UEs, solutions are needed to address how to perform end-to-end L2 Routing based on the UE ID fields in the SRAP header that are independently allocated by each U2U Relay UE hop by hop. FIG. 7 shows an example procedure of a U2U Relay UE using local UE IDs allocated by the next hop U2U Relay UE for egress traffic.

This embodiment describes an end-to-end L2 Routing procedure with hop-by-hop independently allocated local UE IDs by each U2U Relay UE. This embodiment describes an end-to-end L2 Routing procedure based on the hop-by-hop independently allocated local UE IDs by each U2U Relay UE. On each U2U Relay along the end-to-end path, this embodiment first determines the egress link based on the source and destination UE IDs in the ingress SRAP header, and then maps the set of source and destination UE IDs in the ingress SRAP header to the set of source and destination UE IDs to be used in the egress SRAP header:

A U2U Remote UE may send SRAP data using local UE IDs allocated by its next hop U2U Relay UE in the egress SRAP header. A U2U Relay UE may receive SRAP data from the previous hop (U2U Remote UE or U2U Relay UE) with local UE IDs allocated by itself. A U2U Relay UE may determine the egress link to the next hop based on the local UE IDs allocated by itself in the received SRAP header and its L2 Relay Routing Table. If the next hop is a U2U Remote UE, a U2U Relay UE may send SRAP data to the next hop U2U Remote UE using local UE IDs allocated by itself in the egress SRAP header. Otherwise, a U2U Relay UE may perform UE local UE ID swapping (from the local UE IDs allocated by itself in the received SRAP header to the local UE IDs allocated by the next hop U2U Relay UE) and ma send SRAP data to the next hop U2U Relay UE using local UE IDs allocated by the next hop. A U2U Remote UE may receive SRAP data with local UE IDs allocated by its previous hop U2U Relay UE.

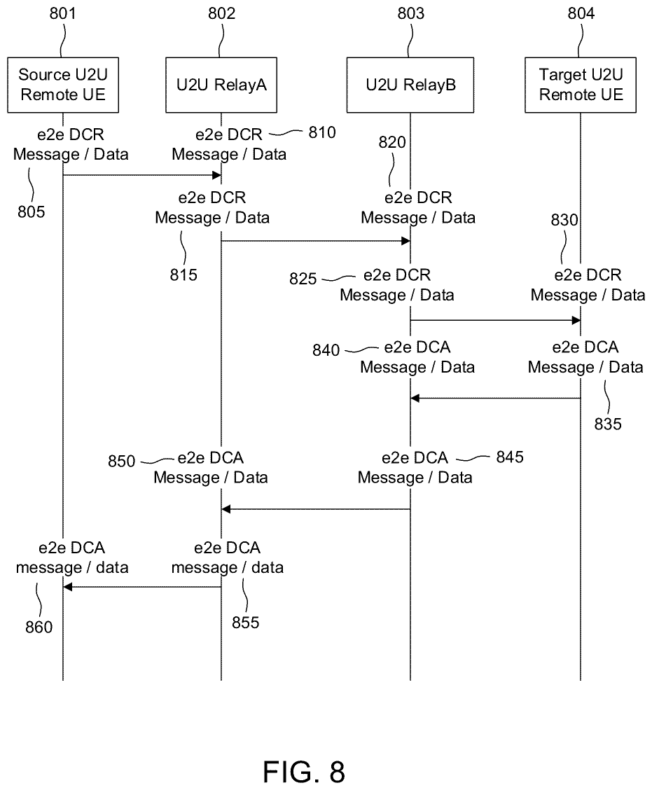

FIG. 8 shows an example procedure of the fourth embodiment of a U2U relay UE using local UE IDs allocated by the next hop U2U Relay UE for egress traffic.

The source U2U Remote UE 801 may send an end-to-end Direct Communication Request (e2e DCR) message for end-to-end PC5 link establishment/connection setup or data traffic 805 to the target U2U Remote UE via U2U RelayA UE 802. The ProSe layer of the source U2U Remote UE may provide [E2E source Layer-2 ID, E2E target Layer-2 ID] to AS layer. The AS layer of the source U2U Remote UE may determine the [source UE ID, destination UE ID] in the egress SRAP header based on the mapping between [E2E source Layer-2 ID, E2E target Layer-2 ID] and the local UE IDs allocated by U2U RelayA UE (here, [source UE IDa, target UE IDa]). The AS layer of the source U2U Remote UE may determine the egress link based on the next-hop Layer-2 ID in the L2 Relay Routing Table entry corresponding to [source UE ID, destination UE ID]=[source UE IDa, target UE IDa], where: Source UE ID: source UE IDa; Destination UE ID: target UE IDa; Number of Hops to Destination: 3; and/or Next Hop Layer-2 ID: source Layer-2 ID of U2U RelayA UE.

U2U RelayA UE 802 may receive the e2e DCR message or data traffic 810 from the source U2U Remote UE 801, with [source UE ID, destination UE ID] in the SRAP header set to [source UE IDa, target UE IDa].

U2U RelayA UE 802 may send an e2e DCR message or data traffic 815 to U2U RelayB UE 803. The AS layer of U2U RelayA UE may determine the egress link based on the next-hop Layer-2 ID in the L2 Relay Routing Table entry corresponding to [source UE ID, destination UE ID]=[source UE IDa, target UE IDa], where: Source UE ID: source UE Ida; Destination UE ID: target UE Ida; Number of Hops to Destination: 2; and/or Next Hop Layer-2 ID: source Layer-2 ID of U2U RelayB UE. The AS layer of U2U RelayA UE may perform local UE ID swapping to use the local UE IDs allocated by U2U RelayB UE (here, [source UE IDb, target UE IDb]) as the [source UE ID, destination UE ID] in the egress SRAP header based on the Next-hop UE ID Mapping Table entry with next-hop Layer-2 ID=source Layer-2 ID of U2U RelayB UE, where: Next-hop Layer-2 ID: [source Layer-2 ID of U2U RelayB UE]; Ingress UE IDs: [source UE IDa, target UE IDa]; and Egress UE IDs: [source UE IDb, target UE IDb].

U2U RelayB UE 803 may receive the e2e DCR message or data traffic 820 from U2U RelayA UE 802, with [source UE ID, destination UE ID] in the SRAP header set to [source UE IDb, target UE IDb].

U2U RelayB UE 803 may send an e2e DCR message or data traffic 825 to the target U2U Remote UE 804. The AS layer of U2U RelayB UE may determine the egress link based on the next-hop Layer-2 ID in the L2 Relay Routing Table entry corresponding to [source UE ID, destination UE ID]=[source UE IDb, target UE IDb], where: Source UE ID: source UE IDb; Destination UE ID: target UE IDb; Number of Hops to Destination: 1 (directly connected); and/or Next Hop Layer-2 ID: source Layer-2 ID of the target U2U Remote UE. The AS layer of U2U RelayB UE maps ingress UE IDs to egress UE IDs based on the Next-hop UE ID Mapping Table entry with next-hop Layer-2 ID=source Layer-2 ID of the target U2U Remote UE, where: Next-hop Layer-2 ID: [source Layer-2 ID of the target U2U Remote UE]; Ingress UE IDs: [source UE IDb, target UE IDb]; and/or Egress UE IDs: [source UE IDb, target UE IDb].

The target U2U Remote UE 804 may receive an e2e DCR message or data traffic 830 from U2U RelayB UE 803, with [source UE ID, destination UE ID] in the SRAP header set to [source UE IDb, target UE IDb]. When the AS layer of the target U2U Remote UE receives an e2e DCR message or data traffic from U2U RelayB UE, with ingress source Layer-2 ID=source Layer-2 ID of U2U RelayB UE and [source UE ID, destination UE ID] in the SRAP header=[source UE IDb, target UE IDb] allocated by U2U RelayB UE for the end-to-end link associated with [E2E source Layer-2 ID, E2E target Layer-2 ID], SRAP sublayer of the target U2U Remote UE passes the received e2e DCR message or data traffic to the corresponding PDCP entity in the PDCP sublayer based on the bearer ID in the SRAP header.

The target U2U Remote UE 804 may send an end-to-end Direct Communication Accept (e2e DCA) message or data traffic 835 to the source U2U Remote UE via U2U RelayB UE 803. The ProSe layer of the target U2U Remote UE may provide [E2E source Layer-2 ID, E2E target Layer-2 ID] to AS layer. The AS layer of the target U2U Remote UE may determine the [source UE ID destination UE ID] in the egress SRAP header based on the mapping between [E2E source Layer-2 ID, E2E target Layer-2 ID] and the local UE IDs allocated by U2U RelayB UE (here, [source UE IDb, target UE IDb]). The AS layer of the target U2U Remote UE may determine the egress link based on the next-hop Layer-2 ID in the L2 Relay Routing Table entry corresponding to [source UE ID, destination UE ID]=[target UE IDb, source UE IDb], where: Source UE ID: target UE IDb; Destination UE ID: source UE IDb; Number of Hops to Destination: 3; Next Hop Layer-2 ID: source Layer-2 ID of U2U RelayB UE.

U2U RelayB UE 803 may receive the e2e DCA message or data traffic 840 from the target U2U Remote UE 804, with [source UE ID, destination UE ID] in the SRAP header set to [target UE IDb, source UE IDb].

U2U RelayB UE 803 may send an e2e DCA message or data traffic 845 to U2U RelayA UE 802. The AS layer of U2U RelayB UE may determine the egress link based on the next-hop Layer-2 ID in the L2 Relay Routing Table entry corresponding to [source UE ID, destination UE ID]=[target UE IDb, source UE IDb], where: Source UE ID: target UE IDb; Destination UE ID: source UE IDb; Number of Hops to Destination: 2; and/or Next Hop Layer-2 ID: source Layer-2 ID of U2U RelayA UE. The AS layer of U2U RelayB UE may perform local UE ID swapping to use the local UE IDs allocated by U2U RelayA UE (here, [target UE IDa, source UE IDa]) as the [source UE ID, destination UE ID] in the egress SRAP header based on the Next-hop UE ID Mapping Table entry with next-hop Layer-2 ID=source Layer-2 ID of U2U RelayA UE, where: Next-hop Layer-2 ID: [source Layer-2 ID of U2U RelayA UE]; Ingress UE IDs: [target UE IDb, source UE IDb]; and/or Egress UE IDs: [target UE IDa, source UE IDa].

U2U RelayA UE 802 may receive the e2e DCA message or data traffic 850 from U2U RelayB UE 803, with [source UE ID, destination UE ID] in the SRAP header set to [target UE IDa, source UE IDa].

U2U RelayA UE 802 may send an e2e DCA message or data traffic 855 to the source U2U Remote UE 801. The AS layer of U2U RelayA UE may determine the egress link based on the next-hop Layer-2 ID in the L2 Relay Routing Table entry corresponding to [source UE ID, destination UE ID]=[target UE IDa, source UE IDa], where: Source UE ID: target UE IDa; Destination UE ID: source UE IDa; Number of Hops to Destination: 1 (directly connected); and/or Next Hop Layer-2 ID: source Layer-2 ID of the source U2U Remote UE. The AS layer of U2U RelayA UE may map ingress UE IDs to egress UE IDs based on the Next-hop UE ID Mapping Table entry with next-hop Layer-2 ID=source Layer-2 ID of the source U2U Remote UE, where: Next-hop Layer-2 ID: [source Layer-2 ID of the source U2U Remote UE]; Ingress UE IDs: [target UE IDa, source UE IDa]; and/or Egress UE IDs: [target UE IDa, source UE IDa].

The source U2U Remote UE 801 may receive the e2e DCA message or data traffic 860 from U2U RelayA UE 802, with [source UE ID, destination UE ID] in the SRAP header set to [target UE IDa, source UE IDa]. When the AS layer of the source U2U Remote UE receives an e2e DCA message or data traffic from the U2U RelayA UE, with ingress source Layer-2 ID=source Layer-2 ID of U2U RelayA UE and [source UE ID, destination UE ID] in the SRAP header=[target UE IDa, source UE IDa] allocated by U2U RelayA UE for the end-to-end link associated with [E2E source Layer-2 ID, E2E target Layer-2 ID], SRAP sublayer of the source U2U Remote UE passes the received e2e DCA message or data traffic to the corresponding PDCP entity in the PDCP sublayer based on the bearer ID in the SRAP header.

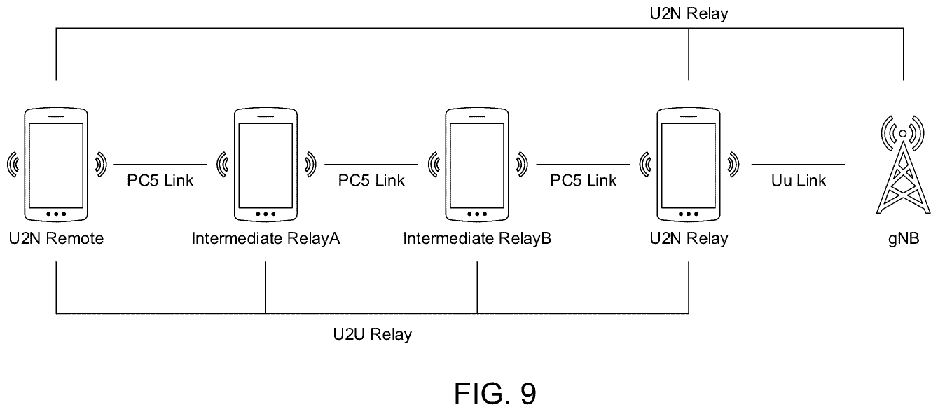

FIG. 9 shows an example multihop Layer-2 UE-to-Network Relay with a “U2U Relay +U2N Relay” architecture. The multihop Layer-2 UE-to-UE Relay capability described herein may be used to support multihop Layer-2 UE-to-Network Relay(U2N) via a “U2U Relay +U2N Relay” architecture, as shown in FIG. 9.

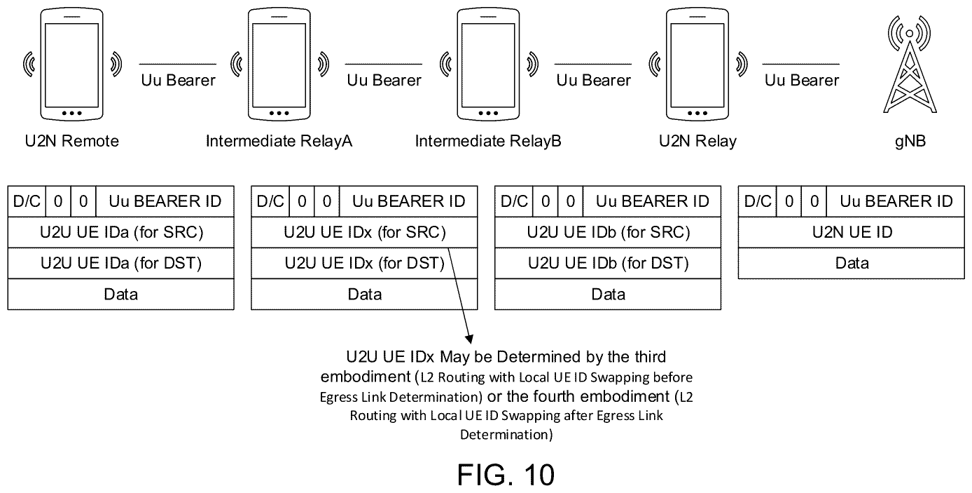

In an embodiment, translation between U2N UE ID and U2U UE IDs in a multihop Layer-2 UE-to-Network Relay may be performed as shown in FIG. 10. A U2U UE IDx may be determined by, for example, the third embodiment (Layer-2 (L2) routing may be performed with local UE ID swapping before egress link determination) or the fourth embodiment (Layer-2 (L2) routing may be performed with local UE ID swapping after egress link determination) as described above.

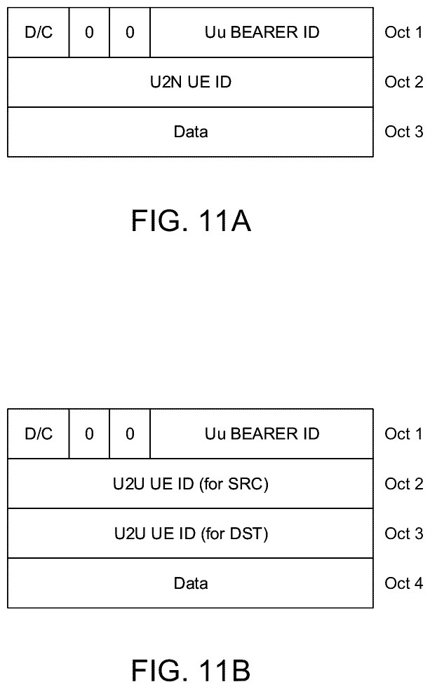

In this embodiment, the Uu SRAP Data PDU format is applicable to U2N SRAP SDU delivered over a Uu interface, as shown in FIG. 11A. The U2N UE ID may be 8 bits and may carry the local identity of the U2N Remote UE. The U2N Remote UE and U2N Relay UE may be configured by a base station (e.g. gNB) with the U2N UE ID of the U2N Remote UE. The Uu BEARER ID may be 5 bits and may carry information to identify a Uu radio bearer for the U2N Remote UE.

The PC5 SRAP Data PDU format may be applicable to U2N SRAP SDU delivered over a PC5 interface, as shown in FIG. 11B. The U2U UE ID may be 8 bits. There may be two U2U UE ID fields: one for the U2N Remote UE (e.g. U2U UE ID (for Source (SRC)), and one for the U2N Relay UE (e.g. U2U UE ID (for Destination (DST)). In this disclosure, U2U UE IDs are independently allocated by each intermediate Relay UE. The Uu BEARER ID may be 5 bits and may carry information to identify a Uu radio bearer for the U2N Remote UE.

A U2N Remote UE may maintain a mapping or association between U2N UE ID and U2U UE IDa of U2N Remote UE. On the uplink, the U2N Remote UE may send traffic using local UE IDs allocated by intermediate RelayA UE (here, source U2U UE ID=U2U UE IDa of U2N Remote UE, destination U2U UE ID=U2U UE IDa of U2N Relay UE). On the downlink, the PC5-SRAP sublayer at the U2N Remote UE may correlate the received packets with the correct PDCP entity associated with the given end-to-end Uu Radio Bearer based on the identity information (destination U2U UE ID=U2U UE IDa of U2N Remote UE, and Uu Bearer ID) included in the PC5 SRAP header, and the mapping between the U2U UE IDa of U2N Remote UE and U2N UE ID of U2N Remote UE.

Layer-2 UE-to-UE Relay between U2N Remote UE and U2N Relay UE may be performed via, for example, the third embodiment (Layer-2 (L2) routing may be performed with local UE ID swapping before egress link determination) or the fourth embodiment (Layer-2 (L2) routing may be performed with local UE ID swapping after egress link determination).

A U2N Relay UE may maintain a mapping or association between U2N UE ID and U2U UE IDb of the U2N Remote UE. On the uplink, the U2N Relay UE may select the U2N UE ID in the Uu-SRAP header based on the source U2U UE ID (=U2U UE IDb of U2N Remote UE) in the PC5-SRAP header. On the downlink, the U2N Relay UE may send traffic using local UE IDs allocated by intermediate RelayB UE (here, source U2U UE ID=U2U UE IDb of U2N Relay UE, destination U2U UE ID=U2U UE IDb of U2N Remote UE associated with the U2N UE ID in the received Uu-SRAP header).

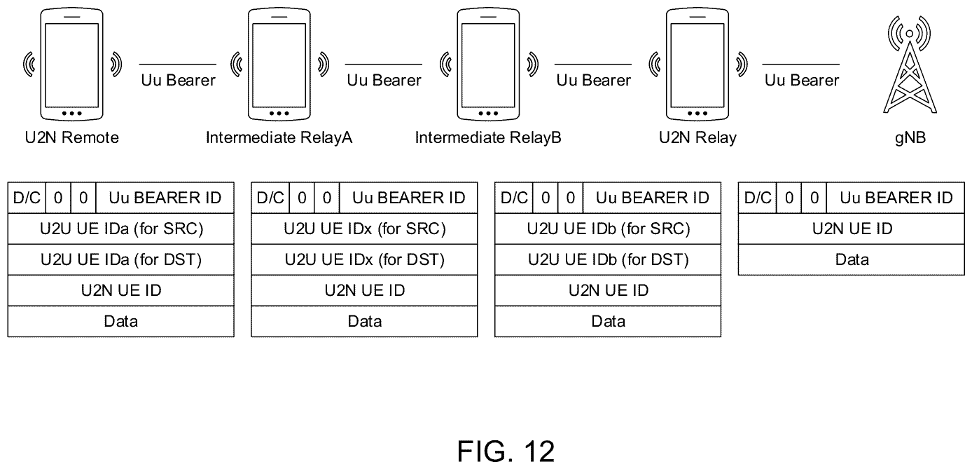

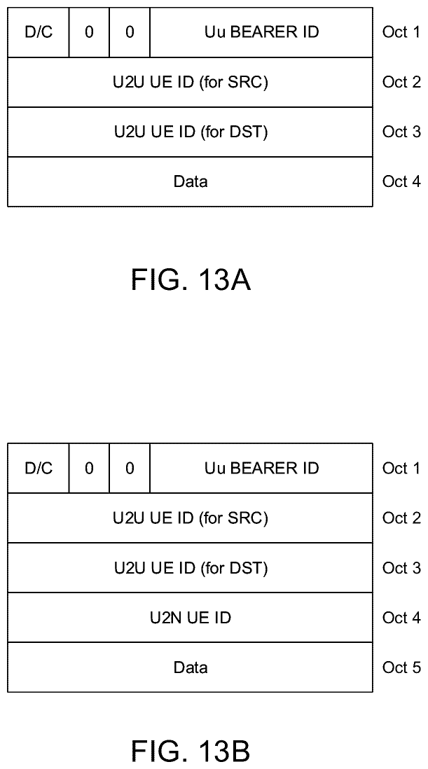

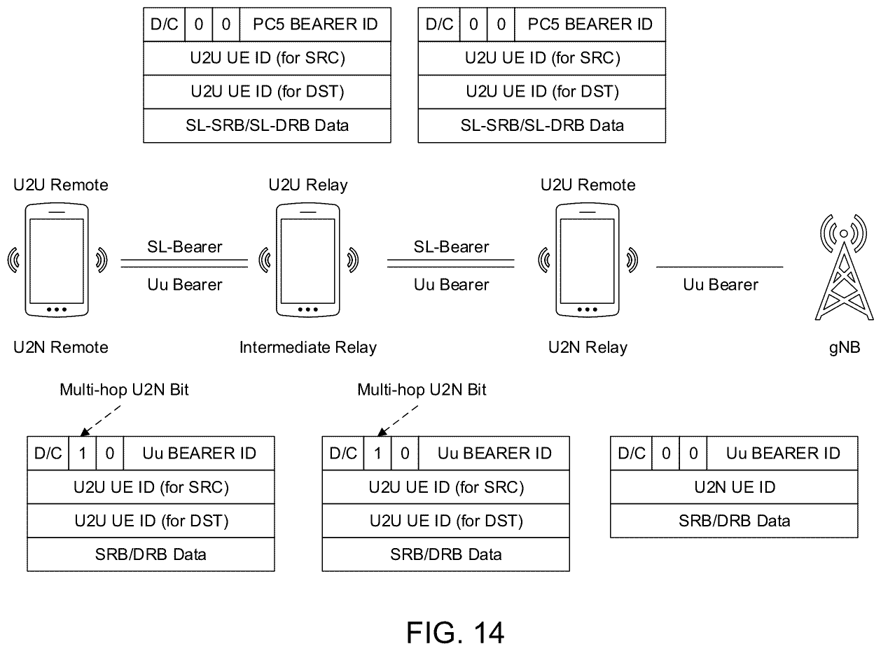

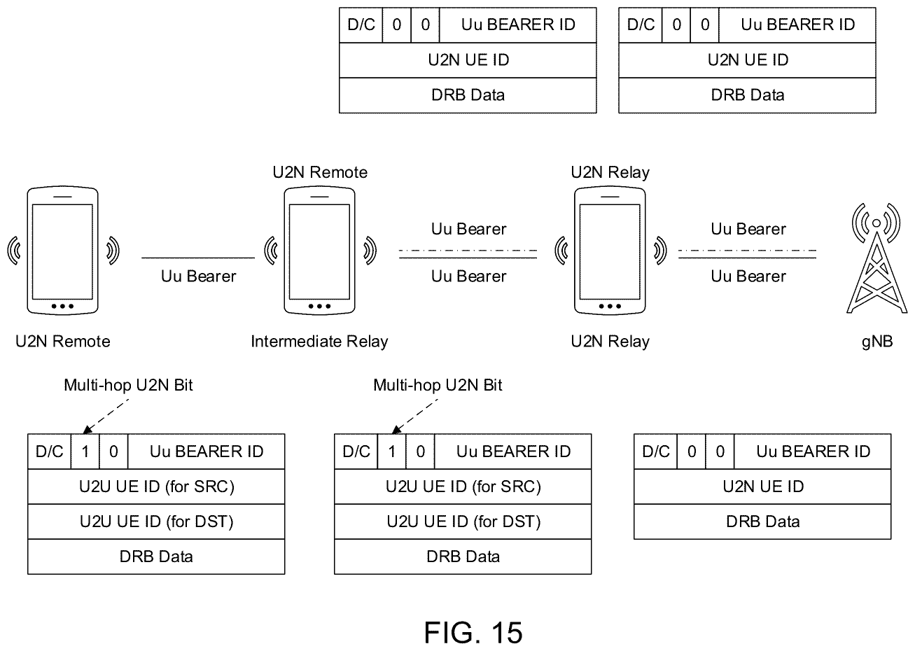

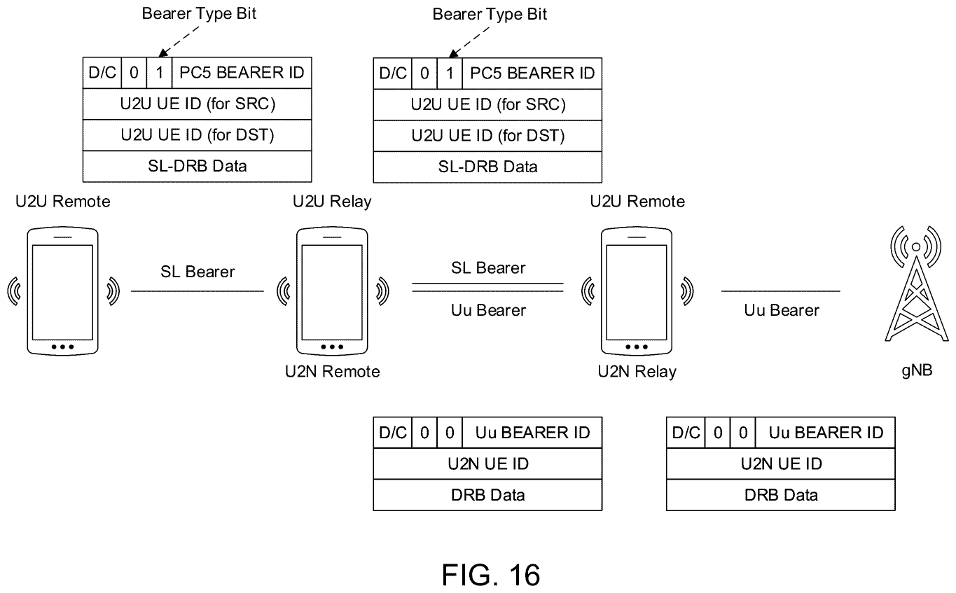

In an embodiment, encapsulation of a U2N UE ID by U2U UE IDs may be performed, as shown in FIG. 12. FIG. 12 shows an example of multihop Layer-2 U2N Relay via encapsulation of U2N UE ID by U2U UE IDs. A U2U UE IDx may be determined by, for example, the third embodiment (Layer-2 (L2) routing may be performed with local UE ID swapping before egress link determination) or the fourth embodiment (Layer-2 (L2) routing may be performed with local UE ID swapping after egress link determination). In this embodiment, the Uu SRAP Data PDU format is the same as the previous embodiment (as shown in FIG. 11A). The PC5-SRAP Data PDU formats with encapsulation are shown in FIG. 13A and FIG. 13B. FIG. 13A shows an example multihop U2N Relay PC5-SRAP Data PDU format with encapsulation (SRB0). FIG. 13B shows an example multihop U2N Relay PC5-SRAP Data PDU format with encapsulation (non-SRB0). The U2U UE ID may be 8 bits. There may be two U2U UE ID fields: one for the U2N Remote UE, and one for the U2N Relay UE. In this disclosure, U2U UE IDs are independently allocated by each intermediate Relay UE. The U2N UE ID may be 8 bits and may carry a local identity of the U2N Remote UE configured by, for example a gNB. For SRB0, U2N the UE ID is not included, as in Release 18. The Uu BEARER ID may be 5 bits and may carry information to identify a Uu radio bearer for the U2N Remote UE.

A U2N Remote UE may encapsulate/decapsulate a U2N UE ID of a U2N Remote UE. On the uplink, the U2N Remote UE may send traffic using local UE IDs allocated by intermediate RelayA UE (here, source U2U UE ID=U2U UE IDa of U2N Remote UE, destination U2U UE ID=U2U UE IDa of U2N Relay UE). In addition, the U2N Remote UE may encapsulate the U2N UE ID of the U2N Remote UE in the PC5-SRAP header (except for SRB0). On the downlink, the PC5-SRAP sublayer at the U2N Remote UE may correlate the received packets with the correct PDCP entity associated with a given end-to-end Uu Radio Bearer based on the identity information (here, encapsulated U2N UE ID (except for SRB0) and Uu Bearer ID) included in the PC5-SRAP header.

Layer-2 UE-to-UE Relay between U2N Remote UE and U2N Relay UE may be performed via for example, the third embodiment (Layer-2 (L2) routing may be performed with local UE ID swapping before egress link determination) or the fourth embodiment (Layer-2 (L2) routing may be performed with local UE ID swapping after egress link determination).

A U2N Relay UE may decapsulate/encapsulate U2N UE ID of U2N Remote UE. On the uplink, the U2N Relay UE may remove the “outer” source and destination U2U UE IDs in the PC5-SRAP header and may keep the “inner” U2N UE ID of the U2N Remote UE (except for SRB0) for the Uu-SRAP header. On the downlink, the U2N Relay UE may send traffic using local UE IDs allocated by intermediate RelayB UE (here, source U2U UE ID=U2U UE IDb of U2N Relay UE, destination U2U UE ID=U2U UE IDb of U2N Remote UE), with the encapsulated U2N UE ID of U2N Remote UE (except for SRB0).

A U2N Relay UE may also serve as a U2U Remote UE or U2U Relay UE for Layer-2 UE-to-UE Relay communication. In this scenario, a ‘Multihop U2N’ bit may be set in the PC5-SRAP header for the multihop (to be more specific, multi-PC5-hop) Layer-2 UE-to-Network Relay to facilitate sharing of the same PC5 Relay RLC channel (e.g., SL-U2U-RLC) between SRB(s) of multihop Layer-2 UE-to-Network Relay and E2E SL-SRB(s) of Layer-2 UE-to-UE Relay, and sharing of the same PC5 Relay RLC channel between DRB(s) of multihop Layer-2 UE-to-Network Relay and E2E SL-DRB(s) of Layer-2 UE-to-UE Relay.

An intermediate Relay UE may also serve as a U2N Remote UE for single-hop (to be more specific, single-PC5-hop) Layer-2 UE-to-Network Relay communication. In this scenario, the ‘Multihop U2N’ bit may also be used to facilitate the sharing between DRB(s) of single-hop U2N Remote UE and DRB(s) of multihop U2N Remote UE in the same PC5 Relay RLC channel between U2N Relay UE and intermediate Relay/single-hop U2N Remote UE.

Sharing between SRB(s) of a single-hop U2N Remote UE and SRB(s) of a multihop U2N Remote UE in the same PC5 Relay RLC channel between an intermediate Relay/single-hop U2N Remote UE and U2N Relay UE is not required. For single-hop U2N Remote UE, SRB 0 may be mapped to SL-RLC 0 and E2E SRBn (n>0) may be mapped to the configured PC5 Relay RLC channel (or possibly SL-RLC1 for SRB1). For a multihop U2N Remote UE, SRBs (including SRB 0 and SRBn, n>0) may be mapped to a specified PC5 RLC channel (e.g., SL-U2U-RLC).

The U2N Relay UE for single-hop (to be more specific, single-PC5-hop) Layer-2 UE-to-Network Relay may also serve as a U2U Remote UE or U2U Relay UE for Layer-2 UE-to-UE Relay communication. In this scenario, a ‘Bearer Type’ bit may be defined to facilitate sharing of the same PC5 Relay RLC channel between DRB(s) of single-hop Layer-2 UE-to-Network Relay and E2E SL-DRB(s) of Layer-2 UE-to-UE Relay (e.g., Bearer Type=1 to indicate “SL Radio Bearer”; Bearer Type=0 to indicate “Unspecified”).

Sharing between SRB(s) of single-hop Layer-2 UE-to-Network Relay and E2E SL-SRB(s) of Layer-2 UE-to-UE Relay in the same PC5 Relay RLC channel is not required. For a single-hop U2N Remote UE, SRB0 may be mapped to SL-RLC 0 and E2E SRBn (n>0) may be mapped to the configured PC5 Relay RLC channel (or possibly SL-RLC 1 for SRB1). For Layer-2 UE-to-UE Relay, E2E SL-SRBs may be mapped to a dedicated PC5 Relay RLC channel (SL-U2U-RLC).

In an embodiment, the second embodiment (Layer-2 routing may be based on SRAP source and destination UE IDs) may be combined with the fourth embodiment (Layer-2 routing may be performed with local UE ID swapping after egress link determination).

Regarding the second embodiment (Layer-2 routing may be based on SRAP source and destination UE IDs), during multihop PC5 connection setup, the ProSe layer of each U2U Relay UE may provide a number of hops and a next-hop Layer-2 ID to the source U2U Remote UE, a number of hops and a next-hop Layer-2 ID to the target U2U Remote UE, as well as E2E source Layer-2 ID and E2E target Layer-2 ID to the AS layer.

U2U RelayA UE may allocate one local UE ID for the E2E source Layer-2 ID and one local UE ID for the E2E target Layer-2 ID and may send the locally assigned source/target UE IDs and the corresponding E2E source/target Layer-2 IDs to the source U2U Remote UE and U2U RelayB UE.

U2U RelayB UE may allocate one local UE ID for the E2E source Layer-2 ID and one local UE ID for the E2E target Layer-2 ID and may send the locally assigned source/target UE IDs and the corresponding E2E source/target Layer-2 IDs to the target U2U Remote UE and U2U RelayA UE.

Source U2U Remote UE and each U2U Relay UE may set up a route entry to the target U2U Remote UE in a L2 Relay Routing Table for egress link determination of traffic from the source U2U Remote UE to the target U2U Remote UE.

Target U2U Remote UE and each U2U Relay UE may set up a route entry to the source U2U Remote UE in a L2 Relay Routing Table for egress link determination of traffic from the target U2U Remote UE to source U2U Remote UE.

Each U2U Relay UE may set up a Next-Hop UE ID Mapping Table for local UE ID swapping, as needed.

Regarding the fourth embodiment (Layer-2 routing may be performed with local UE ID swapping after egress link determination), and with regard to FIG. 4, FIG. 7, and FIG. 8, traffic may be routed from source U2U Remote UE to target U2U Remote UE.

Source U2U Remote UE may apply the local UE IDs allocated by U2U RelayA UE (here, [source UE IDa, target UE IDa]) in the egress SRAP header. U2U RelayA UE may determine the egress link based on the [source UE IDa, target UE IDa] in the received SRAP header and its local L2 Relay Routing Table. U2U RelayA UE may map or associate [source UE IDa, target UE IDa] to the local UE IDs allocated by U2U RelayB UE (here, [source UE IDb, target UE IDb]) based on the Next-Hop UE ID Mapping Table and may apply [source UE IDb, target UE IDb] in the egress SRAP header when sending traffic to U2U RelayB UE. U2U RelayB UE may determine the egress link based on the [source UE IDb, target UE IDb] in the received SRAP header and its local L2 Relay Routing Table. U2U RelayB UE may apply [source UE IDb, target UE IDb] in the egress SRAP header when sending traffic to target U2U Remote UE.

Traffic may be routed from target U2U Remote UE to source U2U Remote UE. Target U2U Remote UE may apply the local UE IDs allocated by U2U RelayB UE (here, [target UE IDb, source UE IDb]) in the egress SRAP header. U2U RelayB UE may determine the egress link based on the [target UE IDb, source UE IDb] in the received SRAP header and its local L2 Relay Routing Table. U2U RelayB UE may map or associate [target UE IDb, source UE IDb] to the local UE IDs allocated by U2U RelayA UE (here, [target UE IDa, source UE IDa]) based on the Next-Hop UE ID Mapping Table and may apply [target UE IDa, source UE IDa] in the egress SRAP header when sending traffic to U2U RelayA UE. U2U RelayA UE may determine the egress link based on the [target UE IDa, source UE IDa] in the received SRAP header and its local L2 Relay Routing Table. U2U RelayA UE may apply [target UE IDa, source UE IDa] in the egress SRAP header when sending traffic to source U2U Remote UE.

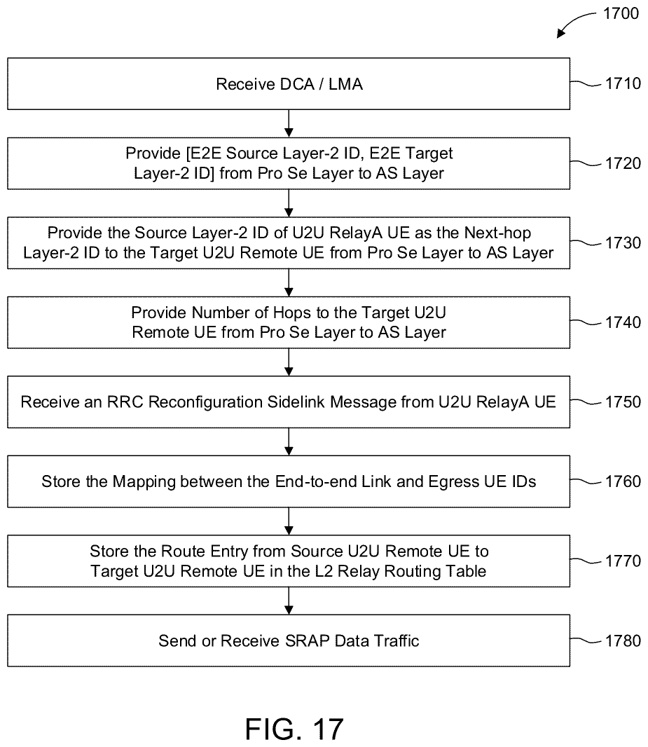

FIG. 17 shows an example procedure 1700 for a Source UE-to-UE (U2U) Remote UE. Source U2U Remote UE may set up an L2 Relay Routing Table (e.g. using procedures in the second embodiment). Source U2U Remote UE may receive a Direct Communication Accept (DCA) or Link Modification Accept (LMA) 1710 from U2U RelayA UE. The ProSe layer of source U2U Remote UE may send [E2E source Layer-2 ID, E2E target Layer-2 ID] to the AS layer to identify the end-to-end link 1720. In an example, [E2E source Layer-2 ID, E2E target Layer-2 ID] may be obtained from procedures in the first embodiment. In an example, the E2E source Layer-2 ID and the E2E target Layer-2 ID may be the Layer-2 ID of the source U2U Remote UE and the Layer-2 ID of the target U2U Remote UE. The ProSe layer may provide the source Layer-2 ID of U2U RelayA UE (e.g., associated with the received DCA/LMA message from U2U RelayA UE) as the next-hop Layer-2 ID to the target U2U Remote UE, to the AS layer 1730. The ProSe layer may provide a number of hops to the target U2U Remote UE (here, 3) to the AS layer 1740.

Source U2U Remote UE may receive a message 1750 (e.g. an RRCReconfigurationSidelink message) from U2U RelayA UE, which may include [source UE IDa, target UE IDa] and [E2E source Layer-2 ID, E2E target Layer-2 ID]. Source U2U Remote UE may store the mapping or association between end-to-end link [E2E source Layer-2 ID, E2E target Layer-2 ID] and egress UE IDs [source UE IDa, target UE IDa] 1760. Source U2U Remote UE may store the route entry from source U2U Remote UE to target U2U Remote UE in the L2 Relay Routing Table 1770, which may include: Source UE ID: source UE IDa; Destination UE ID: target UE IDa; Number of Hops to Destination: 3, and Next Hop Layer-2 ID: source Layer-2 ID of U2U RelayA UE.

Source U2U Remote UE may route traffic from Source U2U Remote UE to Target U2U Remote UE (e.g. using procedures in the fourth embodiment) 1780. Source U2U Remote UE may send SRAP data traffic to the target U2U Remote UE via U2U RelayA UE. Source U2U Remote UE may determine egress UE IDs for the end-to-end link associated with [E2E source Layer-2 ID, E2E target Layer-2 ID], where Egress UE IDs: [source UE IDa, target UE IDa]. Source U2U Remote UE may determine the egress link based on the next-hop Layer-2 ID in the L2 Relay Routing Table entry corresponding to [source UE ID, destination UE ID]=[source UE IDa, target UE IDa], where Source UE ID: source UE IDa; Destination UE ID: target UE IDa; Number of Hops to Destination: 3; and Next Hop Layer-2 ID: source Layer-2 ID of U2U RelayA UE. Source U2U Remote UE may send the SRAP data to the next hop (here, U2U RelayA UE) with UE IDs in the SRAP header set to the egress UE IDs (here, [source UE ID, destination UE ID]=[source UE IDa, target UE IDa]).

Traffic may be routed from Target UE to Source UE (e.g. using procedures in the fourth embodiment) 1780. Source U2U Remote UE may receive SRAP data traffic from the target U2U Remote UE via U2U RelayA UE, with UE IDs in the SRAP header set to [target UE IDa, source UE IDa].

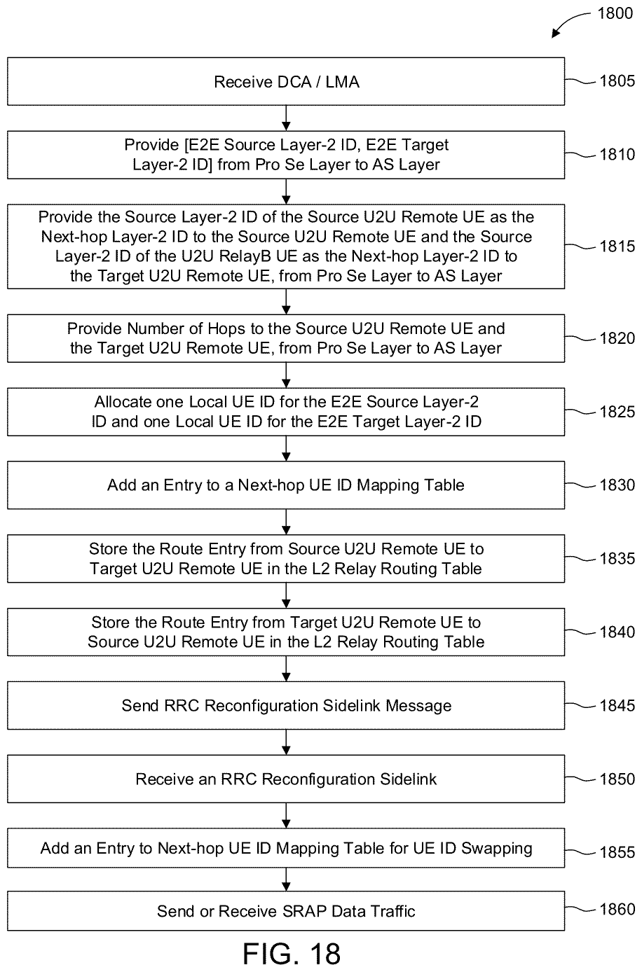

FIG. 18 shows an example procedure 1800 for a UE-to-UE (U2U) Relay UE. U2U RelayA UE may allocate local UE IDs and set up a UE ID Mapping Table and an L2 Relay Routing Table (for example using procedures in the second embodiment). U2U RelayA UE may receive a Direct Communication Accept (DCA) or Link Modification Accept (LMA) 1805 from U2U RelayB UE.

The ProSe layer of U2U RelayA UE may send [E2E source Layer-2 ID, E2E target Layer-2 ID] to the AS layer to identify the end-to-end link 1810. In an example, [E2E source Layer-2 ID, E2E target Layer-2 ID] may be obtained from procedures in the first embodiment. In an example, the E2E source Layer-2 ID and the E2E target Layer-2 ID may be the Layer-2 ID of the source U2U Remote UE and the Layer-2 ID of the target U2U Remote UE. The ProSe layer may provide the source Layer-2 ID of the source U2U Remote UE (e.g., associated with the received Direct Security Mode (DSM) Complete message during security establishment with the source U2U Remote UE after receiving a DCR from the source U2U Remote UE) as the next-hop Layer-2 ID to the source U2U Remote UE and the source Layer-2 ID of the U2U RelayB UE (e.g., associated with the received DCA/LMA message from U2U RelayB UE) as the next-hop Layer-2 ID to the target U2U Remote UE, to the AS layer 1815. The ProSe layer may provide a number of hops to the source U2U Remote UE (here, 1) and number of hops to the target U2U Remote UE (here, 2) to AS layer 1820.

The AS layer of U2U Relay A UE may allocate one local UE ID for the E2E source Layer-2 ID (here, source UE IDa) and one local UE ID for the E2E target Layer-2 ID (here, target UE IDa) 1825. If the number of hops to the source U2U Remote UE=1 (here, source Layer-2 ID of the source U2U Remote UE=next-hop Layer-2 ID to the source U2U Remote UE received from the ProSe layer), the AS layer may add an entry to a Next-hop UE ID Mapping Table to source U2U Remote UE 1830: Next-hop Layer-2 ID: [source Layer-2 ID of the source U2U Remote UE]; Ingress UE IDs: [target UE IDa, source UE IDa]; and Egress UE IDs: [target UE IDa, source UE IDa]. The AS layer may store the route entry from source U2U Remote UE to target U2U Remote UE in the L2 Relay Routing Table 1835, where Source UE ID: source UE IDa; Destination UE ID: target UE IDa; Number of Hops to Destination: 2; and Next Hop Layer-2 ID: source Layer-2 ID of U2U RelayB UE. The AS layer may store the route entry from target U2U Remote UE to source U2U Remote UE in the L2 Relay Routing Table 1840, where Source UE ID: target UE IDa; Destination UE ID: source UE IDa; Number of Hops to Destination: 1 (directly connected); and Next Hop Layer-2 ID: source Layer-2 ID of the source U2U Remote UE.

Notification of Allocated SRAP UE IDs may be performed for example as in the second embodiment. U2U RelayA UE may send messages 1845 (e.g. RRCReconfigurationSidelink messages) to the source U2U Remote UE and U2U RelayB UE, which may include locally assigned [source UE IDa, target UE IDa] and the associated [E2E source Layer-2 ID, E2E target Layer-2 ID].

The Next-hop UE ID Mapping Table entry for UE ID swapping may be set up, for example as in the second embodiment. U2U RelayA UE may receive a message (e.g. an RRC Reconfiguration Sidelink message) from U2U RelayB UE 1850, which may include [source UE IDb, target UE IDb] and [E2E source Layer-2 ID, E2E target Layer-2 ID]. U2U RelayA UE may add an entry to a Next-hop UE ID Mapping Table to U2U RelayB UE for UE ID swapping 1855 based on the association with [E2E source Layer-2 ID, E2E target Layer-2 ID], if source Layer-2 ID of U2U RelayB UE=next-hop Layer-2 ID to the target U2U Remote UE: Next-hop Layer-2 ID: [source Layer-2 ID of U2U RelayB UE]; Ingress UE IDs: [source UE IDa, target UE IDa]; and Egress UE IDs: [source UE IDb, target UE IDb].

Traffic may be routed from Source U2U Remote UE to Target U2U Remote UE 1860 (e.g. using procedures in the fourth embodiment). U2U Relay A UE may receive SRAP data traffic from the source U2U Remote UE (with previous-hop Layer-2 ID=source U2U Remote UE Layer-2 ID). U2U Relay A UE may extract the SRAP [source UE ID, destination UE ID] from the SRAP header (here, [source UE IDa, target UE IDa]). U2U Relay A UE may determine the egress link based on the next-hop Layer-2 ID in the L2 Relay Routing Table entry corresponding to [source UE ID, destination UE ID]=[source UE IDa, target UE IDa], where Source UE ID: source UE IDa; Destination UE ID: target UE IDa; Number of Hops to Destination: 2; and Next Hop Layer-2 ID: source Layer-2 ID of U2U RelayB UE. U2U Relay A UE may map or associate ingress UE IDs to egress UE IDs based on the Next-hop UE ID Mapping Table entry with next-hop Layer-2 ID=source Layer-2 ID of U2U RelayB UE, where Next-hop Layer-2 ID: [source Layer-2 ID of U2U RelayB UE]; Ingress UE IDs: [source UE IDa, target UE IDa] and Egress UE IDs: [source UE IDb, target UE IDb]. U2U Relay A UE may send the received SRAP data to the next hop (here, U2U RelayB UE) with UE IDs in the SRAP header set to the egress UE IDs (here, [source UE ID, destination UE ID]=[source UE IDb, target UE IDb]).

Traffic may be routed from Target U2U Remote UE to Source U2U Remote UE 1860 (e.g. using procedures in the fourth embodiment). U2U Relay A UE may receive SRAP data traffic from U2U RelayB UE (with previous-hop Layer-2 ID=source Layer-2 ID of U2U RelayB UE). U2U Relay A UE may extract the SRAP [source UE ID, destination UE ID] from the SRAP header (here, [target UE IDa, source UE IDa]). U2U Relay A UE may determine the egress link based on the next-hop Layer-2 ID in the L2 Relay Routing Table entry corresponding to [source UE ID, destination UE ID]=[target UE IDa, source UE IDa], where Source UE ID: target UE IDa; Destination UE ID: source UE IDa; Number of Hops to Destination: 1 (directly connected); and Next Hop Layer-2 ID: source Layer-2 ID of the source U2U Remote UE. U2U Relay A UE may map or associate ingress UE IDs to egress UE IDs based on the Next-hop UE ID Mapping Table entry with next-hop Layer-2 ID=source Layer-2 ID of the source U2U Remote UE, where Next-hop Layer-2 ID: [source Layer-2 ID of the source U2U Remote UE]; Ingress UE IDs: [target UE IDa, source UE IDa]; and Egress UE IDs: [target UE IDa, source UE IDa]. U2U Relay A UE may send the received SRAP data to the next hop (here, source U2U Remote UE) with UE IDs in the SRAP header set to the egress UE IDs (here, [source UE ID, destination UE ID]=[target UE IDa, source UE IDa]).

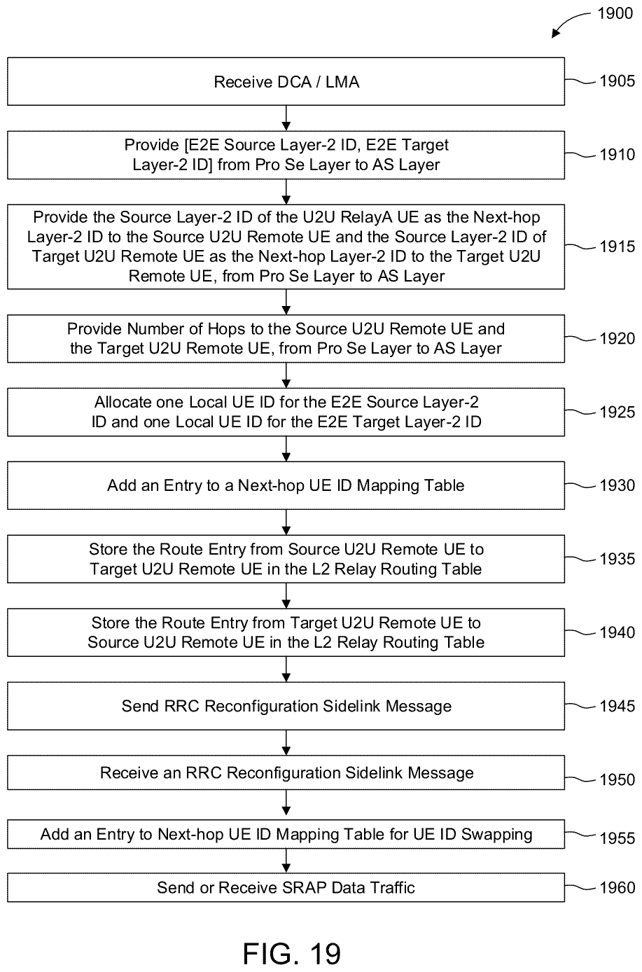

FIG. 19 shows an example procedure 1900 for a UE-to-UE (U2U) Relay UE. U2U RelayB UE may allocate local UE IDs and set up a UE ID Mapping Table and an L2 Relay Routing Table (for example using procedures in the second embodiment). U2U RelayB UE may receive a Direct Communication Accept (DCA) or Link Modification Accept (LMA) 1905 from the target U2U Remote UE.

The ProSe layer of U2U RelayB UE may send [E2E source Layer-2 ID, E2E target Layer-2 ID] to the AS layer to identify the end-to-end link 1910. In an example, [E2E source Layer-2 ID, E2E target Layer-2 ID] may be obtained from procedures in the first embodiment. In an example, the E2E source Layer-2 ID and the E2E target Layer-2 ID may be the Layer-2 ID of the source U2U Remote UE and the Layer-2 ID of the target U2U Remote UE. The ProSe layer may provide the source Layer-2 ID of U2U RelayA UE (e.g., associated with the received Direct Security Mode (DSM) Complete message during security establishment with U2U RelayA UE after receiving the DCR from U2U RelayA UE) as the next-hop Layer-2 ID to the source U2U Remote UE and the source Layer-2 ID of the target U2U Remote UE (e.g., associated with the received DCA/LMA message from U2U RelayB UE) as the next-hop Layer-2 ID to the target U2U Remote UE, to the AS layer 1915. The ProSe layer may provide a number of hops to the source U2U Remote UE (here, 2) and number of hops to the target U2U Remote UE (here, 1) to the AS layer 1920.

The AS layer of the U2U RelayB UE may allocate one local UE ID for the E2E source Layer-2 ID (here, source UE IDb) and one local UE ID for the E2E target Layer-2 ID (here, target UE IDb) 1925. If the number of hops to the target U2U Remote UE=1 (here, source Layer-2 ID of the target U2U Remote UE=next-hop Layer-2 ID to the target U2U Remote UE received from ProSe layer), the AS layer may add the following entry to a Next-hop UE ID Mapping Table to target U2U Remote UE 1930: Next-hop Layer-2 ID: [source Layer-2 ID of the target U2U Remote UE]; Ingress UE IDs: [source UE IDb, target UE IDb]; and Egress UE IDs: [source UE IDb, target UE IDb]. The AS layer may store the route entry from source U2U Remote UE to target U2U Remote UE in the L2 Relay Routing Table 1935, where Source UE ID: source UE IDb; Destination UE ID: target UE IDb; Number of Hops to Destination: 1 (directly connected); and Next Hop Layer-2 ID: source Layer-2 ID of the target U2U Remote UE. The AS layer may store the route entry from target U2U Remote UE to source U2U Remote UE in the L2 Relay Routing Table 1940, where Source UE ID: target UE IDb; Destination UE ID: source UE IDb; Number of Hops to Destination: 2 and Next Hop Layer-2 ID: source Layer-2 ID of U2U RelayA UE.

Notification of Allocated SRAP UE IDs may be performed for example as in the second embodiment. U2U RelayB UE may send messages 1945 (e.g. RRCReconfigurationSidelink messages) to the target U2U Remote UE and U2U RelayA UE, which may include locally assigned [source UE IDb, target UE IDb] and the associated [E2E source Layer-2 ID, E2E target Layer-2 ID].

The Next-hop UE ID Mapping Table entry for UE ID swapping may be set up for example as in the second embodiment. U2U RelayB UE may receive a message (e.g. an RRC Reconfiguration Sidelink message) from U2U RelayA UE 1950, which may include [source UE IDa, target UE IDa] and [E2E source Layer-2 ID, E2E target Layer-2 ID]. U2U RelayB UE may add an entry to a Next-hop UE ID Mapping Table to U2U RelayA UE for UE ID swapping 1955 based on the association with [E2E source Layer-2 ID, E2E target Layer-2 ID]. If source Layer-2 ID of U2U RelayA UE=next-hop Layer-2 ID to the source U2U Remote UE: Next-hop Layer-2 ID: [source Layer-2 ID of U2U RelayA UE]; Ingress UE IDs: [target UE IDb, source UE IDb]; and Egress UE IDs: [target UE IDa, source UE IDa].

Traffic may be routed from Source U2U Remote UE to Target U2U Remote UE 1960 (e.g. using procedures in the fourth embodiment). U2U RelayB UE may receive SRAP data traffic from U2U RelayA UE (with previous-hop Layer-2 ID=source Layer-2 ID of U2U RelayA UE). U2U RelayB UE may extract the SRAP [source UE ID, destination UE ID] from the SRAP header (here, [source UE IDb, target UE IDb]). U2U RelayB UE may determine the egress link based on the next-hop Layer-2 ID in the L2 Relay Routing Table entry corresponding to [source UE ID, destination UE ID]=[source UE IDb, target UE IDb], where Source UE ID: source UE IDb; Destination UE ID: target UE IDb; Number of Hops to Destination: 1 (directly connected); and Next Hop Layer-2 ID: source Layer-2 ID of the target U2U Remote UE. U2U RelayB UE may map or associate ingress UE IDs to egress UE IDs based on the Next-hop UE ID Mapping Table entry with next-hop Layer-2 ID=source Layer-2 ID of the target U2U Remote UE, where Next-hop Layer-2 ID: [source Layer-2 ID of the target U2U Remote UE]; Ingress UE IDs: [source UE IDb, target UE IDb]; and Egress UE IDs: [source UE IDb, target UE IDb]. U2U RelayB UE may send the received SRAP data to the next hop (here, target U2U Remote UE) with UE IDs in the SRAP header set to the egress UE IDs (here, [source UE ID, destination UE ID]=[source UE IDb, target UE IDb]).

Traffic may be routed from Target U2U Remote UE to Source U2U Remote UE 1960 (e.g. using procedures in the fourth embodiment). U2U RelayB UE may receive SRAP data traffic from the target U2U Remote UE (with previous-hop Layer-2 ID=source Layer-2 ID of the target U2U Remote UE). U2U RelayB UE may extract the SRAP [source UE ID, destination UE ID] from the SRAP header (here, [target UE IDb, source UE IDb]). U2U RelayB UE may determine the egress link based on the next-hop Layer-2 ID in the L2 Relay Routing Table entry corresponding to [source UE ID, destination UE ID]=[target UE IDb, source UE IDb], where Source UE ID: target UE IDb; Destination UE ID: source UE IDb; Number of Hops to Destination: 2; and Next Hop Layer-2 ID: source Layer-2 ID of U2U RelayA UE. U2U RelayB UE may map or associate ingress UE IDs to egress UE IDs based on the Next-hop UE ID Mapping Table entry with next-hop Layer-2 ID=source Layer-2 ID of U2U RelayA UE, where Next-hop Layer-2 ID: [source Layer-2 ID of U2U RelayA UE]; Ingress UE IDs: [target UE IDb, source UE IDb]; and Egress UE IDs: [target UE IDa, source UE IDa]. U2U RelayB UE may send the received SRAP data to the next hop (here, U2U RelayA UE) with UE IDs in the SRAP header set to the egress UE IDs (here, [source UE ID, destination UE ID]=[target UE IDa, source UE IDa]).

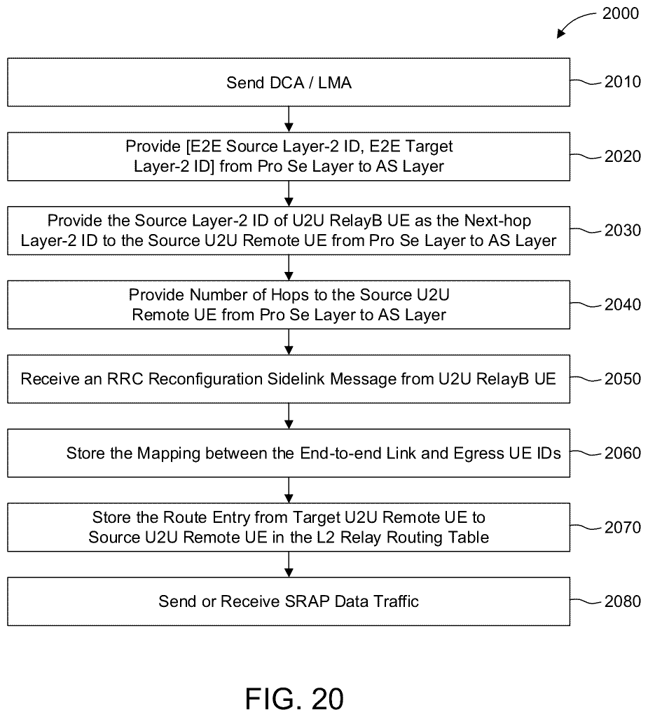

FIG. 20 shows an example procedure 2000 for a Target UE-to-UE (U2U) Remote UE. Target U2U Remote UE may set up an L2 Relay Routing Table (for example, using procedure from the second embodiment). Target U2U Remote UE may send a Direct Communication Accept (DCA) or Link Modification Accept (LMA) 2010 to U2U RelayB UE. The ProSe layer of target U2U Remote UE may send [E2E source Layer-2 ID, E2E target Layer-2 ID] to the AS layer to identify the end-to-end link 2020. In an example, [E2E source Layer-2 ID, E2E target Layer-2 ID] may be obtained from procedures from the first embodiment. In an example, the E2E source Layer-2 ID and the E2E target Layer-2 ID may be the Layer-2 ID of the source U2U Remote UE and the Layer-2 ID of the target U2U Remote UE. The ProSe layer may provide the source Layer-2 ID of U2U RelayB UE (e.g., associated with the received Direct Security Mode (DSM) Complete message during security establishment with U2U RelayB UE after receiving the DCR from U2U RelayB UE) as the next-hop Layer-2 ID to the source U2U Remote UE, to AS layer 2030. The ProSe layer may provide a number of hops to the source U2U Remote UE (here, 3) to the AS layer 2040.

Target U2U Remote UE may receive a message 2050 (e.g. an RRCReconfigurationSidelink message) from U2U RelayB UE, which may include [source UE IDb, target UE IDb] and [E2E source Layer-2 ID, E2E target Layer-2 ID]. Target U2U Remote UE may store the mapping or association between end-to-end link [E2E source Layer-2 ID, E2E target Layer-2 ID] and egress UE IDs [target UE IDb, source UE IDb] 2060. Target U2U Remote UE may store the route entry from target U2U Remote UE to source U2U Remote UE in the L2 Relay Routing Table 2070, where Source UE ID: target UE IDb; Destination UE ID: source UE IDb; Number of Hops to Destination: 3; and Next Hop Layer-2 ID: source Layer-2 ID of U2U RelayB UE.

Traffic may be routed from Source U2U Remote UE to Target U2U Remote UE 2080 (for example using procedures from the fourth embodiment). Target U2U Remote UE may receive SRAP data traffic from the source U2U Remote UE via U2U RelayB UE, with UE IDs in the SRAP header set to [source UE IDb, target UE IDb].

Traffic may be routed from Target U2U Remote UE to Source U2U Remote UE 2080 (for example using procedures from the fourth embodiment). Target U2U Remote UE may send SRAP data traffic to the source U2U Remote UE via U2U RelayB UE. Target U2U Remote UE may determine egress UE IDs for the end-to-end link associated with [E2E source Layer-2 ID, E2E target Layer-2 ID], where Egress UE IDs: [target UE IDb, source UE IDb]. Target U2U Remote UE may determine the egress link based on the next-hop Layer-2 ID in the L2 Relay Routing Table entry corresponding to [source UE ID, destination UE ID]=[target UE IDb, source UE IDb], where Source UE ID: target UE IDb; Destination UE ID: source UE IDb; Number of Hops to Destination: 3; and Next Hop Layer-2 ID: source Layer-2 ID of U2U RelayB UE. Target U2U Remote UE may send the SRAP data to the next hop (here, U2U RelayB UE) with UE IDs in the SRAP header set to the egress UE IDs (here, [source UE ID, destination UE ID]=[target UE IDb, source UE IDb]).

In an embodiment, the second embodiment (Layer-2 routing may be based on SRAP source and destination UE IDs) may be combined with the third embodiment (Layer-2 routing may be performed with local UE ID swapping before egress link determination).

Regarding the second embodiment (Layer-2 routing may be based on SRAP source and destination UE IDs), during multihop PC5 connection setup, the ProSe layer of each U2U Relay UE may provide a number of hops and next-hop Layer-2 ID to the source U2U Remote UE, a number of hops and next-hop Layer-2 ID to the target U2U Remote UE, as well as E2E source Layer-2 ID and E2E target Layer-2 ID to the AS layer.

U2U RelayA UE may allocate one local UE ID for the E2E source Layer-2 ID and one local UE ID for the E2E target Layer-2 ID and may send the locally assigned source/target UE IDs and the corresponding E2E source/target Layer-2 IDs to source U2U Remote UE and U2U RelayB UE.

U2U RelayB UE may allocate one local UE ID for the E2E source Layer-2 ID and one local UE ID for the E2E target Layer-2 ID and may send the locally assigned source/target UE IDs and the corresponding E2E source/target Layer-2 IDs to target U2U Remote UE and U2U RelayA UE.

Source U2U Remote UE and each U2U Relay UE may set up a route entry to the target U2U Remote UE in the L2 Relay Routing Table for egress link determination of traffic from source U2U Remote UE to target U2U Remote UE.

Target U2U Remote UE and each U2U Relay UE may set up a route entry to the source U2U Remote UE in the L2 Relay Routing Table for egress link determination of traffic from target U2U Remote UE to source U2U Remote UE.

Each U2U Relay UE may set up a Previous-Hop UE ID Mapping Table for local UE ID swapping, as needed.

Regarding the third embodiment (Layer-2 routing may be performed with local UE ID swapping before egress link determination), and with regard to FIG. 4, FIG. 5, and FIG. 6, traffic may be routed from source U2U Remote UE to target U2U Remote UE. Source U2U Remote UE may apply the local UE IDs allocated by U2U RelayA UE (here, [source UE IDa, target UE IDa]) in the egress SRAP header. U2U RelayA UE may use the [source UE IDa, target UE IDa] in the received SRAP header as the local UE IDs in the egress SRAP header and may determine the egress link based on [source UE IDa, target UE IDa] and its local L2 Relay Routing Table. U2U RelayB UE may map the [source UE IDa, target UE IDa] in the received SRAP header to local UE IDs allocated by itself (here, [source UE IDb, target UE IDb]) based on the Previous-Hop UE ID Mapping Table and then determine the egress link based on the mapped [source UE IDb, target UE IDb] and its local L2 Relay Routing Table. U2U RelayB UE may apply [source UE IDb, target UE IDb] in the egress SRAP header when sending traffic to target U2U Remote UE.

Traffic may be routed from target U2U Remote UE to source U2U Remote UE. Target U2U Remote UE may apply the local UE IDs allocated by U2U RelayB UE (here, [target UE IDb, source UE IDb]) in the egress SRAP header. U2U RelayB UE may use the [target UE IDb, source UE IDb] in the received SRAP header as the local UE IDs in the egress SRAP header and determine the egress link based on [target UE IDb, source UE IDb] and its local L2 Relay Routing Table. U2U RelayA UE may map the [target UE IDb, source UE IDb] in the received SRAP header to local UE IDs allocated by itself (here, [target UE IDa, source UE IDa]) based on the Previous-Hop UE ID Mapping Table and then determine the egress link based on the mapped [target UE IDa, source UE IDa] and its local L2 Relay Routing Table. U2U RelayA UE may apply [target UE IDa, source UE IDa] in the egress SRAP header when sending traffic to source U2U Remote UE.

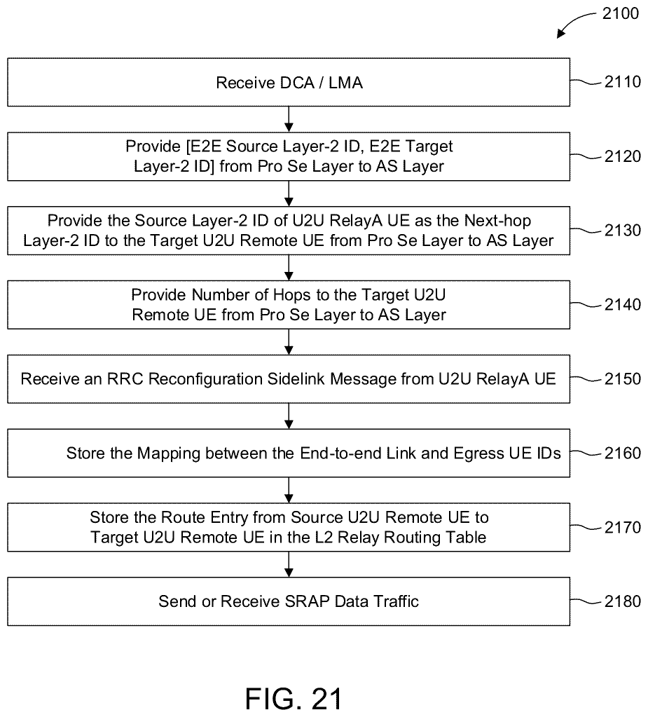

FIG. 21 shows an example procedure 2100 for a Source UE-to-UE (U2U) Remote UE. Source U2U Remote UE may set up an L2 Relay Routing Table using, for example the procedure from the second embodiment. Source U2U Remote UE may receive a Direct Communication Accept (DCA) or Link Modification Accept (LMA) 2110 from U2U RelayA UE.

The ProSe layer of Source U2U Remote UE may send [E2E source Layer-2 ID, E2E target Layer-2 ID] to the AS layer to identify the end-to-end link 2120. In an example, [E2E source Layer-2 ID, E2E target Layer-2 ID] may be obtained from procedures from the first embodiment. In an example, the E2E source Layer-2 ID and the E2E target Layer-2 ID may be the Layer-2 ID of the source U2U Remote UE and the Layer-2 ID of the target U2U Remote UE. The ProSe layer may provide the source Layer-2 ID of U2U RelayA UE (e.g., associated with the received DCA/LMA message from U2U RelayA UE) as the next-hop Layer-2 ID to the target U2U Remote UE, to AS layer 2130. The ProSe layer may provide a number of hops to the target U2U Remote UE (here, 3) to the AS layer 2140.

Source U2U Remote UE may receive a message 2150 (e.g. an RRCReconfigurationSidelink message) from U2U RelayA UE, which may include [source UE IDa, target UE IDa] and [E2E source Layer-2 ID, E2E target Layer-2 ID]. Source U2U Remote UE may store the mapping or association between end-to-end link [E2E source Layer-2 ID, E2E target Layer-2 ID] and egress UE IDs [source UE IDa, target UE IDa] 2160. Source U2U Remote UE may store the route entry from source U2U Remote UE to target U2U Remote UE in the L2 Relay Routing Table 2170, where Source UE ID: source UE IDa; Destination UE ID: target UE IDa; Number of Hops to Destination: 3; and Next Hop Layer-2 ID: source Layer-2 ID of U2U RelayA UE.

Traffic may be routed from Source U2U Remote UE to Target U2U Remote UE, for example using procedures from the third embodiment.

Source U2U Remote UE may send SRAP data traffic to the target U2U Remote UE 2180 via U2U RelayA UE. Source U2U Remote UE may determine egress UE IDs for the end-to-end link associated with [E2E source Layer-2 ID, E2E target Layer-2 ID], where Egress UE IDs: [source UE IDa, target UE IDa]. Source U2U Remote UE may determine the egress link based on the next-hop Layer-2 ID in the L2 Relay Routing Table entry corresponding to [source UE ID, destination UE ID]=[source UE IDa, target UE IDa], where Source UE ID: source UE IDa; Destination UE ID: target UE IDa; Number of Hops to Destination: 3 and Next Hop Layer-2 ID: source Layer-2 ID of U2U RelayA UE. Source U2U Remote UE may send the SRAP data to the next hop (here, U2U RelayA UE) with UE IDs in the SRAP header set to the egress UE IDs (here, [source UE ID, destination UE ID]=[source UE IDa, target UE IDa]).

Traffic may be routed from Target U2U Remote UE to Source U2U Remote UE, for example using procedures from the third embodiment. Source U2U Remote UE may receive SRAP data traffic 2180 from the target U2U Remote UE via U2U RelayA UE, with UE IDs in the SRAP header set to [target UE IDa, source UE IDa].

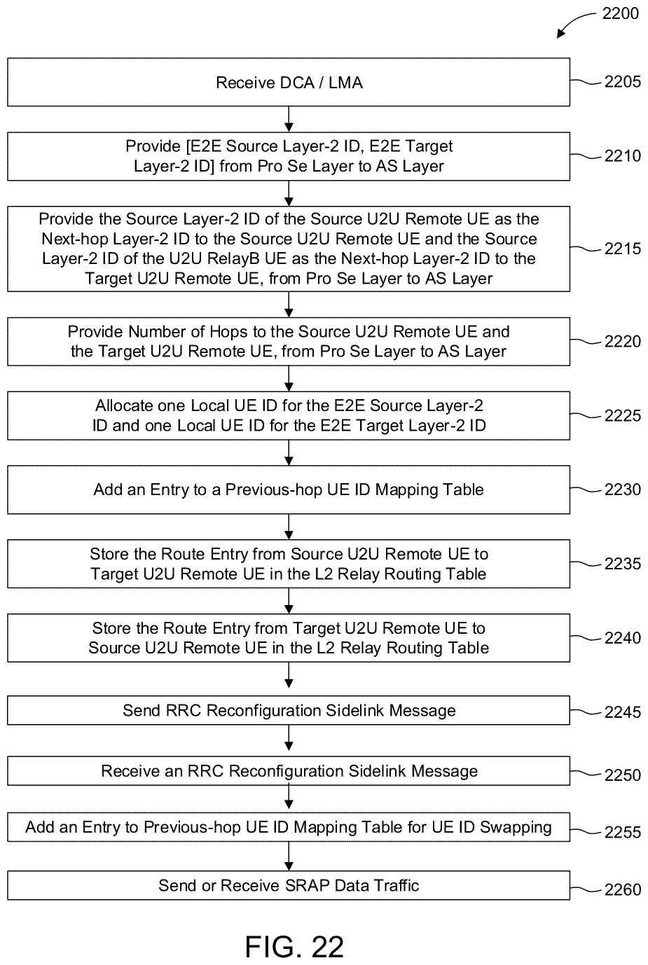

FIG. 22 shows an example procedure for a UE-to-UE (U2U) Relay UE. U2U RelayA UE may allocate local UE IDs and set up a UE ID Mapping Table and an L2 Relay Routing Table (for example using procedures from the second embodiment). U2U RelayA UE may receive a Direct Communication Accept (DCA) or Link Modification Accept (LMA) 2205 from U2U RelayB UE.

The ProSe layer of U2U RelayA UE may send [E2E source Layer-2 ID, E2E target Layer-2 ID] to the AS layer to identify the end-to-end link 2210. In an example, [E2E source Layer-2 ID, E2E target Layer-2 ID] may be obtained from procedures from the first embodiment. In an example, the E2E source Layer-2 ID and the E2E target Layer-2 ID may be the Layer-2 ID of the source U2U Remote UE and the Layer-2 ID of the target U2U Remote UE. The ProSe layer of U2U RelayA UE may provide the source Layer-2 ID of the source U2U Remote UE (e.g., associated with the received Direct Security Mode (DSM) Complete message during security establishment with the source U2U Remote UE after receiving the DCR from the source U2U Remote UE) as the next-hop Layer-2 ID to the source U2U Remote UE and the source Layer-2 ID of the U2U RelayB UE (e.g., associated with the received DCA/LMA message from U2U RelayB UE) as the next-hop Layer-2 ID to the target U2U Remote UE, to the AS layer 2215. The ProSe layer of U2U RelayA UE may provide a number of hops to the source U2U Remote UE (here, 1) and a number of hops to the target U2U Remote UE (here, 2) to the AS layer 2220.

The AS layer of U2U RelayA UE may allocate one local UE ID for the E2E source Layer-2 ID (here, source UE IDa) and one local UE ID for the E2E target Layer-2 ID (here, target UE IDa) 2225. If number of hops to the source U2U Remote UE=1 (here, source Layer-2 ID of the source U2U Remote UE=next-hop Layer-2 ID to the source U2U Remote UE received from ProSe layer), The AS layer of U2U RelayA UE may add the following entry to a Previous-hop UE ID Mapping Table from source U2U Remote UE 2230: Previous-hop Layer-2 ID: [source Layer-2 ID of the source U2U Remote UE]; Ingress UE IDs: [source UE IDa, target UE IDa]; and Egress UE IDs: [source UE IDa, target UE IDa]. The AS layer of U2U RelayA UE may store the route entry from source U2U Remote UE to target U2U Remote UE in the L2 Relay Routing Table 2235, where Source UE ID: source UE IDa; Destination UE ID: target UE IDa; Number of Hops to Destination: 2; and Next Hop Layer-2 ID: source Layer-2 ID of U2U RelayB UE. The AS layer of U2U RelayA UE may store the route entry from target U2U Remote UE to source U2U Remote UE in the L2 Relay Routing Table 2240, where Source UE ID: target UE IDa; Destination UE ID: source UE IDa; Number of Hops to Destination: 1 (directly connected); and Next Hop Layer-2 ID: source Layer-2 ID of the source U2U Remote UE.

Notification of Allocated SRAP UE IDs may be performed for example from procedures from the second embodiment. U2U RelayA UE may send message 2245 (e.g. RRCReconfigurationSidelink messages) to the source U2U Remote UE and U2U RelayB UE, which may include locally assigned [source UE IDa, target UE IDa] and the associated [E2E source Layer-2 ID, E2E target Layer-2 ID].

The Previous-hop UE ID Mapping Table entry for UE ID swapping may be set up for example from procedures from the second embodiment. U2U RelayA UE may receive a message (e.g. an RRC Reconfiguration Sidelink message) from U2U RelayB UE 2250, which may include [source UE IDb, target UE IDb] and [E2E source Layer-2 ID, E2E target Layer-2 ID]. U2U RelayA UE may add an entry to a Previous-hop UE ID Mapping Table from U2U Relay B UE for UE ID swapping 2255 based on the association with [E2E source Layer-2 ID, E2E target Layer-2 ID]. If source Layer-2 ID of U2U RelayB UE=next-hop Layer-2 ID to the target U2U Remote UE: Previous-hop Layer-2 ID: [source Layer-2 ID of U2U RelayB UE]; Ingress UE IDs: [target UE IDb, source UE IDb]; and Egress UE IDs: [target UE IDa, source UE IDa].

Traffic may be routed from Source U2U Remote UE to Target U2U Remote UE (e.g. using procedures from the third embodiment). U2U RelayA UE may receive SRAP data traffic 2260 from the source U2U Remote UE (with previous-hop Layer-2 ID=source U2U Remote UE Layer-2 ID). U2U RelayA UE may extract the SRAP [source UE ID, destination UE ID] from the SRAP header (here, [source UE IDa, target UE IDa]). U2U RelayA UE may map ingress UE IDs to egress UE IDs based on the Previous-hop UE ID Mapping Table entry with previous-hop Layer-2 ID=source Layer-2 ID of the source U2U Remote UE, where Previous-hop Layer-2 ID: [source Layer-2 ID of the source U2U Remote UE]; Ingress UE IDs: [source UE IDa, target UE IDa]; and Egress UE IDs: [source UE IDa, target UE IDa]. U2U RelayA UE may determine the egress link based on the next-hop Layer-2 ID in the L2 Relay Routing Table entry corresponding to [source UE ID, destination UE ID]=[source UE IDa, target UE IDa], where Source UE ID: source UE IDa; Destination UE ID: target UE IDa; Number of Hops to Destination: 2; and Next Hop Layer-2 ID: source Layer-2 ID of U2U RelayB UE. U2U RelayA UE may send the received SRAP data to the next hop (here, U2U RelayB UE) with UE IDs in the SRAP header set to the egress UE IDs (here, [source UE ID, destination UE ID]=[source UE IDa, target UE IDa]).

Traffic may be routed from Target U2U Remote UE to Source U2U Remote UE (e.g. using procedures from the third embodiment). U2U RelayA UE may receive SRAP data traffic 2260 from U2U RelayB UE (with previous-hop Layer-2 ID=source Layer-2 ID of U2U RelayB UE). U2U RelayA UE may extract the SRAP [source UE ID, destination UE ID] from the SRAP header (here, [target UE IDb, source UE IDb]). U2U RelayA UE may map ingress UE IDs to egress UE IDs based on the Previous-hop UE ID Mapping Table entry with previous-hop Layer-2 ID=source Layer-2 ID of U2U RelayB UE, where Previous-hop Layer-2 ID: [source Layer-2 ID of U2U RelayB UE]; Ingress UE IDs: [target UE IDb, source UE IDb]; and Egress UE IDs: [target UE IDa, source UE IDa]. U2U RelayA UE may determine egress link based on the next-hop Layer-2 ID in the L2 Relay Routing Table entry corresponding to [source UE ID, destination UE ID]=[target UE IDa, source UE IDa], where Source UE ID: target UE IDa; Destination UE ID: source UE IDa; Number of Hops to Destination: 1 (directly connected); and Next Hop Layer-2 ID: source Layer-2 ID of the source U2U Remote UE. U2U RelayA UE may send the received SRAP data to the next hop (here, source U2U Remote UE) with UE IDs in the SRAP header set to the egress UE IDs (here, [source UE ID, destination UE ID]=[target UE IDa, source UE IDa]).

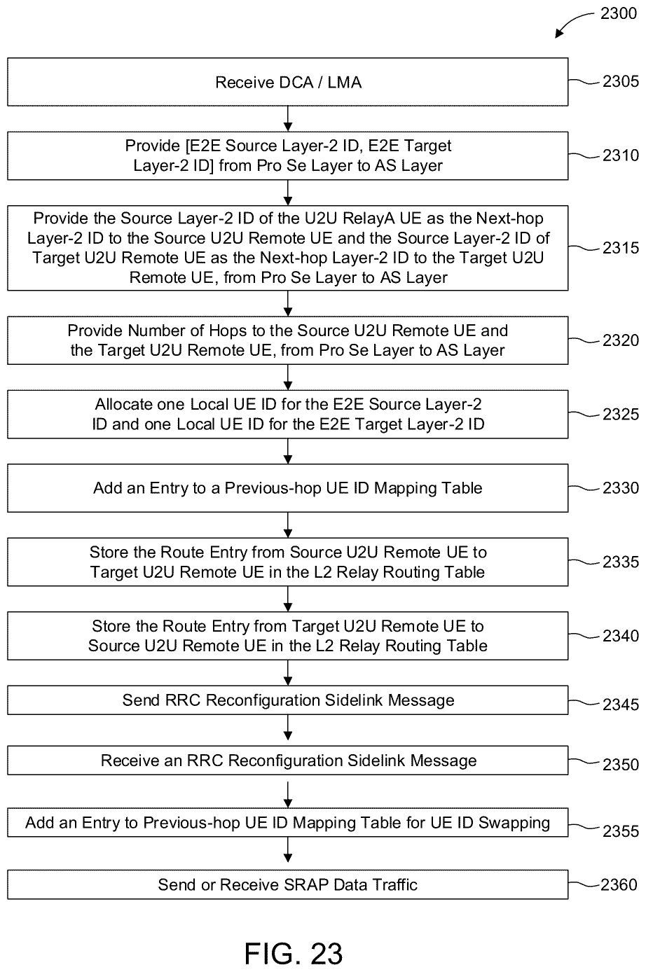

FIG. 23 shows an example procedure for a UE-to-UE (U2U) Relay UE. U2U RelayB UE may allocate local UE IDs and set up a UE ID Mapping Table and an L2 Relay Routing Table (for example using procedures in the second embodiment). U2U RelayB UE may receive a Direct Communication Accept (DCA) or Link Modification Accept (LMA) 2305 from the target U2U Remote UE.

The ProSe layer of U2U RelayB UE may send [E2E source Layer-2 ID, E2E target Layer-2 ID] to the AS layer to identify the end-to-end link 2310. In an example, [E2E source Layer-2 ID, E2E target Layer-2 ID] may be obtained from procedures from the first embodiment. In an example, the E2E source Layer-2 ID and the E2E target Layer-2 ID may be the Layer-2 ID of the source U2U Remote UE and the Layer-2 ID of the target U2U Remote UE. The ProSe layer of U2U RelayB UE may provide the source Layer-2 ID of U2U RelayA UE (e.g., associated with the received Direct Security Mode (DSM) Complete message during security establishment with U2U RelayA UE after receiving the DCR from U2U RelayA UE) as the next-hop Layer-2 ID to the source U2U Remote UE and the source Layer-2 ID of the target U2U Remote UE (e.g., associated with the received DCA/LMA message from U2U RelayB UE) as the next-hop Layer-2 ID to the target U2U Remote UE, to the AS layer 2315. The ProSe layer of U2U RelayB UE may provide a number of hops to the source U2U Remote UE (here, 2) and a number of hops to the target U2U Remote UE (here, 1) to the AS layer 2320.

The AS layer of U2U RelayB UE may allocate one local UE ID for the E2E source Layer-2 ID (here, source UE IDb) and one local UE ID for the E2E target Layer-2 ID (here, target UE IDb) 2325. If number of hops to the target U2U Remote UE=1 (here, source Layer-2 ID of the target U2U Remote UE=next-hop Layer-2 ID to the target U2U Remote UE received from ProSe layer), the AS layer may add the following entry to a Previous-hop UE ID Mapping Table from target U2U Remote UE 2330: Previous-hop Layer-2 ID: [source Layer-2 ID of the target U2U Remote UE]; Ingress UE IDs: [target UE IDb, source UE IDb]; and Egress UE IDs: [target UE IDb, source UE IDb]. The AS layer may store the route entry from source U2U Remote UE to target U2U Remote UE in the L2 Relay Routing Table 2335, where Source UE ID: source UE IDb; Destination UE ID: target UE IDb; Number of Hops to Destination: 1 (directly connected); and Next Hop Layer-2 ID: source Layer-2 ID of the target U2U Remote UE. The AS layer may store the route entry from target U2U Remote UE to source U2U Remote UE in the L2 Relay Routing Table 2340, where Source UE ID: target UE IDb; Destination UE ID: source UE IDb; Number of Hops to Destination: 2; and Next Hop Layer-2 ID: source Layer-2 ID of U2U RelayA UE.

Notification of Allocated SRAP UE IDs may be performed from procedures from the second embodiment. U2U RelayB UE may send messages 2345 (e.g. RRCReconfigurationSidelink messages) to the target U2U Remote UE and U2U RelayA UE, which may include locally assigned [source UE IDb, target UE IDb] and the associated [E2E source Layer-2 ID, E2E target Layer-2 ID].

The UE ID Mapping Table entry for UE ID swapping may be set up from procedures from the second embodiment. U2U RelayB UE may receive a message (e.g. an RRC Reconfiguration Sidelink message) from U2U RelayA UE 2350, which may include [source UE IDa, target UE IDa] and [E2E source Layer-2 ID, E2E target Layer-2 ID]. U2U RelayB UE may add the following entry to a Previous-hop UE ID Mapping Table from U2U RelayA UE for UE ID swapping 2355 based on the association with [E2E source Layer-2 ID, E2E target Layer-2 ID]. If source Layer-2 ID of U2U RelayA UE=next-hop Layer-2 ID to the source U2U Remote UE: Previous-hop Layer-2 ID: [source Layer-2 ID of U2U RelayA UE]; Ingress UE IDs: [source UE IDa, target UE IDa]; and Egress UE IDs: [source UE IDb, target UE IDb].

Traffic may be routed from Source U2U Remote UE to Target U2U Remote UE (e.g. using procedures in the third embodiment). U2U RelayB UE may receive SRAP data traffic 2360 from U2U RelayA UE (with previous-hop Layer-2 ID=source Layer-2 ID of U2U RelayA UE). U2U RelayB UE may extract the SRAP [source UE ID, destination UE ID] from the SRAP header (here, [source UE IDa, target UE IDa]). U2U RelayB UE may map or associate ingress UE IDs to egress UE IDs based on the Previous-hop UE ID Mapping Table entry with previous-hop Layer-2 ID=source Layer-2 ID of U2U RelayA UE, where Previous-hop Layer-2 ID: [source Layer-2 ID of U2U RelayA UE]; Ingress UE IDs: [source UE IDa, target UE IDa]; and Egress UE IDs: [source UE IDb, target UE IDb]. U2U RelayB UE may determine the egress link based on the next-hop Layer-2 ID in the L2 Relay Routing Table entry corresponding to [source UE ID, destination UE ID]=[source UE IDb, target UE IDb], where Source UE ID: source UE IDb; Destination UE ID: target UE IDb; Number of Hops to Destination: 1 (directly connected); and Next Hop Layer-2 ID: source Layer-2 ID of the target U2U Remote UE. U2U RelayB UE may send the received SRAP data to the next hop (here, target U2U Remote UE) with UE IDs in the SRAP header set to the egress UE IDs (here, [source UE ID, destination UE ID]=[source UE IDb, target UE IDb]).

Traffic may be routed from Target U2U Remote UE to Source U2U Remote UE (e.g. using procedures in the third embodiment). U2U RelayB UE may receive SRAP data traffic 2360 from the target U2U Remote UE (with previous-hop Layer-2 ID=source Layer-2 ID of the target U2U Remote UE). U2U RelayB UE may extract the SRAP [source UE ID, destination UE ID] from the SRAP header (here, [target UE IDb, source UE IDb]). U2U RelayB UE may map or associate ingress UE IDs to egress UE IDs based on the Previous-hop UE ID Mapping Table entry with previous-hop Layer-2 ID= source Layer-2 ID of the target U2U Remote UE, where Previous-hop Layer-2 ID: [source Layer-2 ID of the target U2U Remote UE]; Ingress UE IDs: [target UE IDb, source UE IDb]; and Egress UE IDs: [target UE IDb, source UE IDb]. U2U RelayB UE may determine the egress link based on the next-hop Layer-2 ID in the L2 Relay Routing Table entry corresponding to [source UE ID, destination UE ID]=[target UE IDb, source UE IDb], where Source UE ID: target UE IDb; Destination UE ID: source UE IDb; Number of Hops to Destination: 2; and Next Hop Layer-2 ID: source Layer-2 ID of U2U RelayA UE. U2U RelayB UE may send the received SRAP data to the next hop (here, U2U RelayA UE) with UE IDs in the SRAP header set to the egress UE IDs (here, [source UE ID, destination UE ID]=[target UE IDb, source UE IDb]).

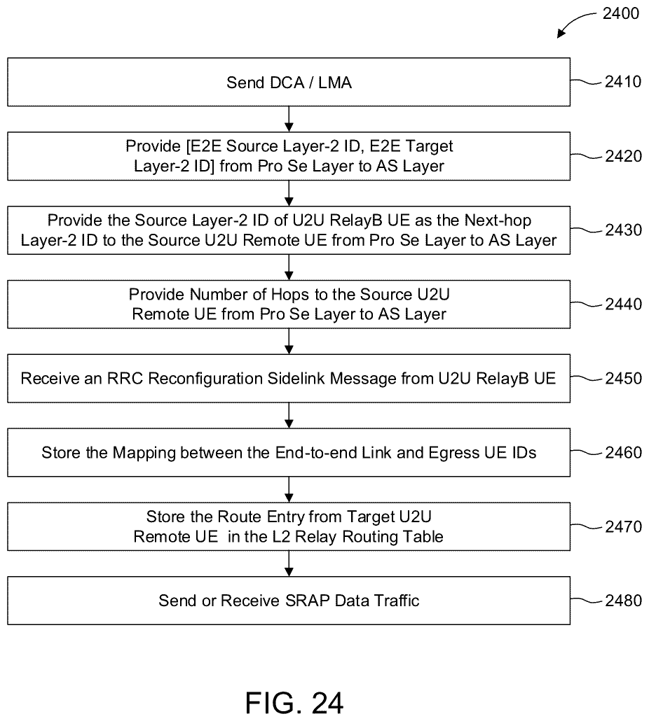

FIG. 24 shows an example procedure for a Target UE-to-UE (U2U) Remote UE. Target U2U Remote UE may set up a L2 Relay Routing (e.g. using procedures in the second embodiment). Target U2U Remote UE may send a Direct Communication Accept (DCA) or Link Modification Accept (LMA) 2410 to U2U RelayB UE. The ProSe layer of target U2U Remote UE may send [E2E source Layer-2 ID, E2E target Layer-2 ID] to the AS layer to identify the end-to-end link 2420. In an example, [E2E source Layer-2 ID, E2E target Layer-2 ID] may be obtained from procedures from the first embodiment. In an example, the E2E source Layer-2 ID and the E2E target Layer-2 ID may be the Layer-2 ID of the source U2U Remote UE and the Layer-2 ID of the target U2U Remote UE. The ProSe layer may provide the source Layer-2 ID of U2U RelayB UE (e.g., associated with the received Direct Security Mode (DSM) Complete message during security establishment with U2U RelayB UE after receiving the DCR from U2U RelayB UE) as the next-hop Layer-2 ID to the source U2U Remote UE, to AS layer 2340. The ProSe layer may provide a number of hops to the source U2U Remote UE (here, 3) to the AS layer 2440.

Target U2U Remote UE may receive a message 2450 (e.g. an RRCReconfigurationSidelink message) from U2U RelayB UE, which may include [source UE IDb, target UE IDb] and [E2E source Layer-2 ID, E2E target Layer-2 ID]. Target U2U Remote UE may store the mapping or association between end-to-end link [E2E source Layer-2 ID, E2E target Layer-2 ID] and egress UE IDs [target UE IDb, source UE IDb] 2460. Target U2U Remote UE may store the route entry from target U2U Remote UE to source U2U Remote UE in the L2 Relay Routing Table 2470, where Source UE ID: target UE IDb; Destination UE ID: source UE IDb; Number of Hops to Destination: 3; and Next Hop Layer-2 ID: source Layer-2 ID of U2U RelayB UE.

Traffic may be routed from Source U2U Remote UE to Target U2U Remote UE (e.g. using procedures in the third embodiment). Target U2U Remote UE may receive SRAP data traffic 2480 from the source U2U Remote UE via U2U RelayB UE, with UE IDs in the SRAP header set to [source UE IDb, target UE IDb].

Traffic may be routed from Target U2U Remote UE to Source U2U Remote UE (e.g. using procedures in the third embodiment). Target U2U Remote UE may send SRAP data traffic 2480 to the source U2U Remote UE via U2U RelayB UE. Target U2U Remote UE may determine egress UE IDs for the end-to-end link associated with [E2E source Layer-2 ID, E2E target Layer-2 ID], where Egress UE IDs: [target UE IDb, source UE IDb]. Target U2U Remote UE may determine the egress link based on the next-hop Layer-2 ID in the L2 Relay Routing Table entry corresponding to [source UE ID, destination UE ID]=[target UE IDb, source UE IDb], where Source UE ID: target UE IDb; Destination UE ID: source UE IDb; Number of Hops to Destination: 3; and Next Hop Layer-2 ID: source Layer-2 ID of U2U RelayB UE. Target U2U Remote UE may send the SRAP data to the next hop (here, U2U RelayB UE) with UE IDs in the SRAP header set to the egress UE IDs (here, [source UE ID, destination UE ID]=[target UE IDb, source UE IDb]).

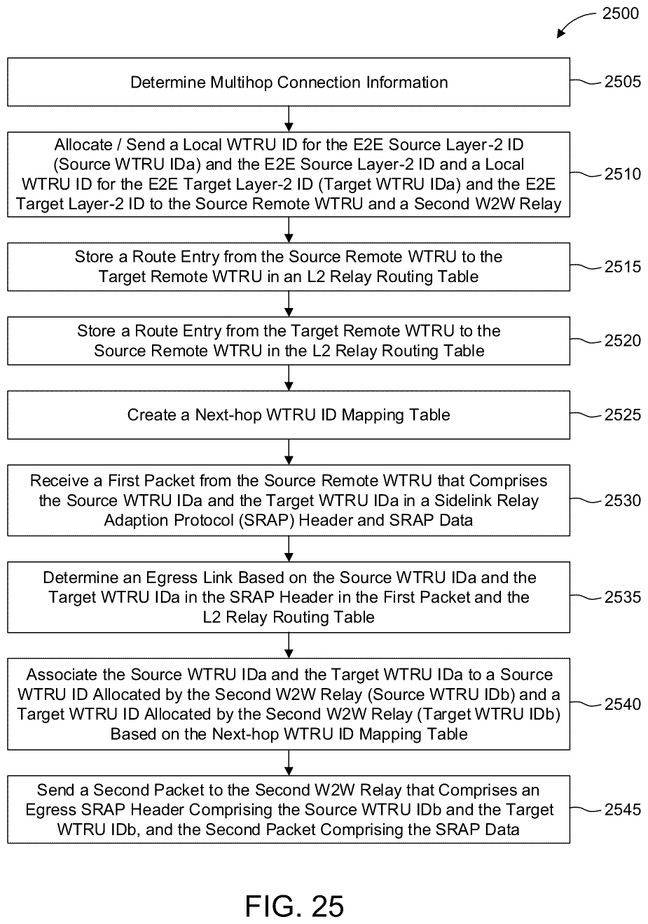

FIG. 25 shows an example procedure 2500 of a UE-to-UE (U2U) Relay UE relating to a combination of the second embodiment and the fourth embodiment. A U2U Relay UE (i.e. WTRU-to-WTRU (W2W) relay) may determine multihop connection information 2505. The multihop connection information may comprise: a number of hops to a source remote WTRU and a next-hop Layer-2 identification (ID) to the source remote WTRU, a number of hops to a target remote WTRU and a next-hop Layer-2 identification (ID) to the target remote WTRU, and end-to-end (E2E) source layer-2 ID and a E2E target layer-2 ID. The multihop connection information may be determined in response to receiving a direct communication request (DCR) message or link modification request (LMR) message from the source remote WTRU, and/or in response to receiving a direct communication accept (DCA) message or link modification accept (LMA) message from the second W2W relay. The multihop connection information may be determined by and/or sent/provided from a proximity service (ProSe) layer to an access stratum (AS) layer in response to receiving a direct communication accept (DCA) message or link modification accept (LMA) message from the second W2W relay. The multihop connection information determination may be performed during a multihop PC5 connection setup procedure.

The W2W relay may allocate and send a local WTRU ID for the E2E source layer-2 ID (source WTRU IDa) and the E2E source layer-2 ID and a local WTRU ID for the E2E target layer-2 ID (target WTRU IDa) and the E2E target layer-2 ID to the source remote WTRU and a second W2W relay 2510. The source WTRU IDa and the target WTRU IDa may be allocated by the AS layer. The source WTRU IDa, the E2E source layer-2 ID, the target WTRU IDa, and the E2E target layer-2 ID may be sent in radio resource control (RRC) reconfiguration sidelink message.

The W2W relay may store a route entry from the source remote WTRU to the target remote WTRU in an L2 relay routing table 2515.

The W2W relay may store a route entry from the target remote WTRU to the source remote WTRU in the L2 relay routing table 2520. A route entry in the L2 relay routing table may comprise: a source WTRU ID, a destination WTRU ID, a number of hops to destination, and/or a next hop layer-2 ID.

The W2W relay may create a next-hop WTRU ID mapping table 2525. The next-hop WTRU ID mapping table may comprise a next-hop layer-2 ID, ingress source and target WTRU IDs, and egress source and target WTRU IDs.

The W2W relay may receive a first packet from the source remote WTRU that comprises the source WTRU IDa and the target WTRU IDa in a sidelink relay adaption protocol (SRAP) header and SRAP data 2530.

The W2W relay may determine an egress link based on the source WTRU IDa and the target WTRU IDa in the SRAP header in the first packet and the L2 relay routing table 2535.

The W2W relay may associate the source WTRU IDa and the target WTRU IDa to a source WTRU ID allocated by the second W2W relay (source WTRU IDb) and a target WTRU ID allocated by the second W2W relay (target WTRU IDb) based on the next-hop WTRU ID mapping table 2540.

The W2W relay may send a second packet to the second W2W relay 2545. The second packet may comprise an egress SRAP header comprising the source WTRU IDb and the target WTRU IDb. The second packet may comprise the SRAP data.

The W2W relay may receive a message from the second W2W relay comprising a second local source WTRU ID (source WTRU IDb), a second local target WTRU ID (target WTRU IDb), the E2E source layer-2 ID, and the E2E target layer-2 ID. The W2W relay may create the next-hop WTRU ID mapping table based on the received message from the second W2W relay.

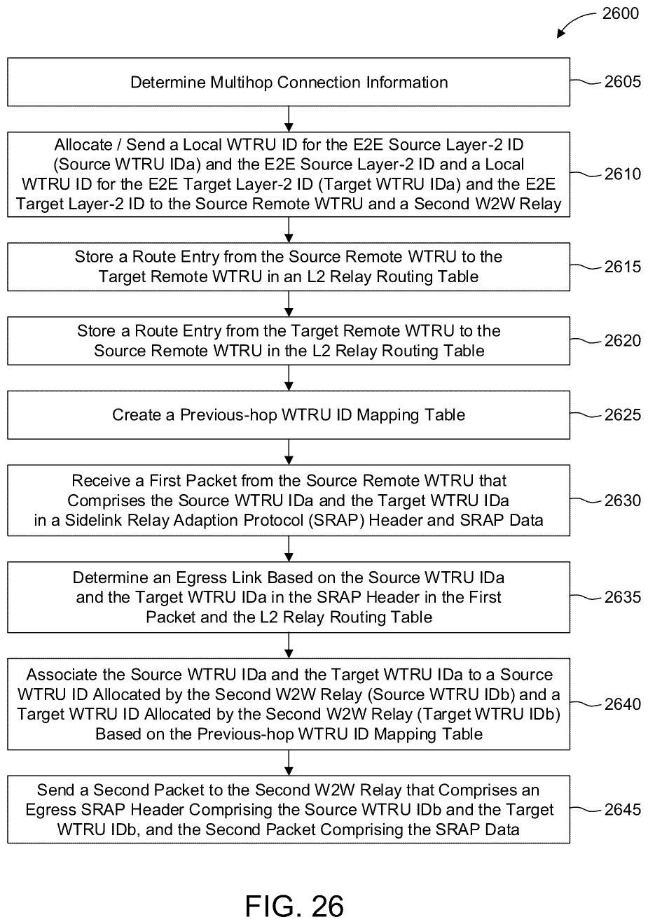

FIG. 26 shows an example procedure 2600 of a UE-to-UE (U2U) Relay UE relating to a combination of the second embodiment and the third embodiment. A U2U Relay UE (i.e. WTRU-to-WTRU (W2W) relay) may determine multihop connection information 2605. The multihop connection information may comprise: a number of hops to a source remote WTRU and a next-hop Layer-2 identification (ID) to the source remote WTRU, a number of hops to a target remote WTRU and a next-hop Layer-2 identification (ID) to the target remote WTRU, and end-to-end (E2E) source layer-2 ID and a E2E target layer-2 ID. The multihop connection information may be determined in response to receiving a direct communication request (DCR) message or link modification request (LMR) message from the source remote WTRU, and/or in response to receiving a direct communication accept (DCA) message or link modification accept (LMA) message from the second W2W relay. The multihop connection information may be determined by and/or sent/provided from a proximity service (ProSe) layer to an access stratum (AS) layer in response to receiving a direct communication accept (DCA) message or link modification accept (LMA) message from the second W2W relay. The multihop connection information determination may be performed during a multihop PC5 connection setup procedure.

The W2W relay may allocate and send a local WTRU ID for the E2E source layer-2 ID (source WTRU IDa) and the E2E source layer-2 ID and a local WTRU ID for the E2E target layer-2 ID (target WTRU IDa) and the E2E target layer-2 ID to the source remote WTRU and a second W2W relay 2610. The source WTRU IDa and the target WTRU IDa may be allocated by the AS layer. The source WTRU IDa, the E2E source layer-2 ID, the target WTRU IDa, and the E2E target layer-2 ID may be sent in radio resource control (RRC) reconfiguration sidelink message.

The W2W relay may store a route entry from the source remote WTRU to the target remote WTRU in an L2 relay routing table 2615.

The W2W relay may store a route entry from the target remote WTRU to the source remote WTRU in the L2 relay routing table 2620. A route entry in the L2 relay routing table may comprise: a source WTRU ID, a destination WTRU ID, a number of hops to destination, and/or a next hop layer-2 ID.

The W2W relay may create a previous-hop WTRU ID mapping table 2625. The previous-hop WTRU ID mapping table may comprise a previous-hop layer-2 ID, ingress source and target WTRU IDs, and egress source and target WTRU IDs.

The W2W relay may receive a first packet from the source remote WTRU that comprises the source WTRU IDa and the target WTRU IDa in a sidelink relay adaption protocol (SRAP) header and SRAP data 2630.

The W2W relay may determine an egress link based on the source WTRU IDa and the target WTRU IDa in the SRAP header in the first packet and the L2 relay routing table 2635.

The W2W relay may associate the source WTRU IDa and the target WTRU IDa to a source WTRU ID allocated by the second W2W relay (source WTRU IDb) and a target WTRU ID allocated by the second W2W relay (target WTRU IDb) based on the previous-hop WTRU ID mapping table 2640.

The W2W relay may send a second packet to the second W2W relay 2545. The second packet may comprise an egress SRAP header comprising the source WTRU IDb and the target WTRU IDb. The second packet may comprise the SRAP data.

The W2W relay may receive a message from the second W2W relay comprising a second local source WTRU ID (source WTRU IDb), a second local target WTRU ID (target WTRU IDb), the E2E source layer-2 ID, and the E2E target layer-2 ID. The W2W relay may create the previous-hop WTRU ID mapping table based on the received message from the second W2W relay.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a wireless transmit/receive unit (WTRU)-to-WTRU (W2W) relay, the method comprising:
determining multihop connection information, wherein the multihop connection information comprises: a number of hops to a source remote WTRU and a next-hop Layer-2 identification (ID) to the source remote WTRU, a number of hops to a target remote WTRU and a next-hop Layer-2 identification (ID) to the target remote WTRU, and an end-to-end (E2E) source layer-2 ID and an E2E target layer-2 ID;
sending, to the source remote WTRU and a second W2W relay: a local WTRU ID for the E2E source layer-2 ID (source WTRU IDa), the E2E source layer-2 ID, a local WTRU ID for the E2E target layer-2 ID (target WTRU IDa), and the E2E target layer-2 ID;
storing a route entry from the source remote WTRU to the target remote WTRU in an L2 relay routing table;
storing a route entry from the target remote WTRU to the source remote WTRU in the L2 relay routing table;
creating a next-hop WTRU ID mapping table;
receiving a first packet from the source remote WTRU that comprises the source WTRU IDa and the target WTRU IDa in a sidelink relay adaption protocol (SRAP) header and SRAP data;
determining an egress link based on the source WTRU IDa and the target WTRU IDa in the SRAP header in the first packet and the L2 relay routing table;
associating the source WTRU IDa and the target WTRU IDa to a source WTRU ID allocated by the second W2W relay (source WTRU IDb) and a target WTRU ID allocated by the second W2W relay (target WTRU IDb) based on the next-hop WTRU ID mapping table; and
sending a second packet to the second W2W relay, wherein the second packet comprises an egress SRAP header that comprises the source WTRU IDb and the target WTRU IDb, and wherein the second packet comprises the SRAP data.

2. The method of claim 1, wherein the determining multihop connection information is in response to:
receiving a direct communication request (DCR) message or a link modification request (LMR) message from the source remote WTRU, and receiving a direct communication accept (DCA) message or a link modification accept (LMA) message from the second W2W relay.

3. The method of claim 1, wherein the multihop connection information is sent from a proximity service (ProSe) layer to an access stratum (AS) layer in response to receiving a direct communication accept (DCA) message or a link modification accept (LMA) message from the second W2W relay.

4. The method of claim 1, wherein the source WTRU IDa, the E2E source layer-2 ID, the target WTRU IDa, and the E2E target layer-2 ID are sent in radio resource control (RRC) reconfiguration sidelink message.

5. The method of claim 1, wherein the source WTRU IDa and the target WTRU IDa are allocated by an access stratum (AS) layer.

6. The method of claim 1, wherein the next-hop WTRU ID mapping table comprises a next-hop layer-2 ID, ingress source and target WTRU IDs, and egress source and target WTRU IDs.

7. The method of claim 1, wherein a route entry in the L2 relay routing table comprises: a source WTRU ID, a destination WTRU ID, a number of hops to destination, and a next hop layer-2 ID.

8. The method of claim 1, further comprising:
receiving a message from the second W2W relay comprising a second local source WTRU ID (source WTRU IDb), a second local target WTRU ID (target WTRU IDb), the E2E source layer-2 ID, and the E2E target layer-2 ID; and
creating the next-hop WTRU ID mapping table based on the received message from the second W2W relay.

9. The method of claim 1, wherein the determining multihop connection information is performed during a multihop PC5 connection setup procedure.

10. The method of claim 1, further comprising swapping local WTRU IDs based on the next-hop WTRU ID mapping table.

11. A wireless transmit/receive unit (WTRU)-to-WTRU (W2W) relay comprising:
a receiver;
a processor; and
a transmitter, wherein:
the processor is configured to determine multihop connection information, wherein the multihop connection information comprises: a number of hops to a source remote WTRU and a next-hop Layer-2 identification (ID) to the source remote WTRU, a number of hops to a target remote WTRU and a next-hop Layer-2 identification (ID) to the target remote WTRU, and end-to-end (E2E) source layer-2 ID and a E2E target layer-2 ID;
the processor and the transmitter are configured to send, to the source remote WTRU and a second W2W relay: a local WTRU ID for the E2E source layer-2 ID (source WTRU IDa), the E2E source layer-2 ID, a local WTRU ID for the E2E target layer-2 ID (target WTRU IDa), and the E2E target layer-2 ID;
the processor is further configured to store a route entry from the source remote WTRU to the target remote WTRU in an L2 relay routing table;
the processor is further configured to store a route entry from the target remote WTRU to the source remote WTRU in the L2 relay routing table;
the processor is further configured to create a next-hop WTRU ID mapping table;
the receiver is configured to receive a first packet from the source remote WTRU that comprises the source WTRU IDa and the target WTRU IDa in a sidelink relay adaption protocol (SRAP) header and SRAP data;
the processor is further configured to determine an egress link based on the source WTRU IDa and the target WTRU IDa in the SRAP header in the first packet and the L2 relay routing table;
the processor is further configured to associate the source WTRU IDa and the target WTRU IDa to a source WTRU ID allocated by the second W2W relay (source WTRU IDb) and a target WTRU ID allocated by the second W2W relay (target WTRU IDb) based on the next-hop WTRU ID mapping table; and
the transmitter is configured to send a second packet to the second W2W relay, wherein the second packet comprises an egress SRAP header that comprises the source WTRU IDb and the target WTRU IDb, and wherein the second packet comprises the SRAP data.

12. The W2W relay of claim 11, wherein the processor is further configured to determine multihop connection information in response to: receiving a direct communication request (DCR) message or a link modification request (LMR) message from the source remote WTRU, and receiving a direct communication accept (DCA) message or a link modification accept (LMA) message from the second W2W relay.

13. The W2W relay of claim 11, wherein the multihop connection information is sent from a proximity service (ProSe) layer to an access stratum (AS) layer in response to receiving a direct communication accept (DCA) message or a link modification accept (LMA) message from the second W2W relay.

14. The W2W relay of claim 11, wherein the source WTRU IDa, the E2E source layer-2 ID, the target WTRU IDa, and the E2E target layer-2 ID are sent in radio resource control (RRC) reconfiguration sidelink message.

15. The W2W relay of claim 11, wherein the source WTRU IDa and the target WTRU IDa are allocated by an access stratum (AS) layer.

16. The W2W relay of claim 11, wherein the next-hop WTRU ID mapping table comprises a next-hop layer-2 ID, ingress source and target WTRU IDs, and egress source and target WTRU IDs.

17. The W2W relay of claim 11, wherein a route entry in the L2 relay routing table comprises: a source WTRU ID, a destination WTRU ID, a number of hops to destination, and a next hop layer-2 ID.

18. The W2W relay of claim 11, wherein:
the receiver is further configured to receive a message from the second W2W relay comprising a second local source WTRU ID (source WTRU IDb), a second local target WTRU ID (target WTRU IDb), the E2E source layer-2 ID, and the E2E target layer-2 ID; and
the processor is further configured to create the next-hop WTRU ID mapping table based on the received message from the second W2W relay.

19. The W2W relay of claim 11, wherein the multihop connection information determination is performed during a multihop PC5 connection setup procedure.

20. The W2W relay of claim 11, wherein the processor is further configured to swap local WTRU IDs based on the next-hop WTRU ID mapping table.
